(19) United States
(12) Patent Application Publication
(10) Pub. No.: US 2013/0081029 A1
(43) Pub. Date: Mar. 28, 2013

(54) Methods and devices for receiving and executing subtasks

(71) Applicants: Royce A. Levien, Lexington, MA (US); Richard T. Lord, Tacoma, WA (US); Robert W. Lord, Seattle, WA (US); Mark A. Malamud, Seattle, WA (US); John D. Rinaldo, JR., Bellevue, WA (US)

(72) Inventors: Royce A. Levien, Lexington, MA (US); Richard T. Lord, Tacoma, WA (US); Robert W. Lord, Seattle, WA (US); Mark A. Malamud, Seattle, WA (US); John D. Rinaldo, JR., Bellevue, WA (US)

(73) Assignee: Elwha LLC, a limited liability company of the State of Delaware

(21) Appl. No.: 13/373,794

(22) Filed: Nov. 29, 2011

Related U.S. Application Data
(63) Continuation-in-part of application No. 13/200,553, filed on Sep. 23, 2011.
Application No. 13/200,553 is a continuation-in-part of application No. 13/200,797, filed on Sep. 30, 2011.
Application No. 13/200,797 is a continuation of application No. 13/373,795, filed on Nov. 29, 2011.
Application No. 13/373,795 is a continuation-in-part of application No. 13/317,591, filed on Oct. 21, 2011.
Application No. 13/317,591 is a continuation-in-part of application No. 13/317,833, filed on Oct. 28, 2011.

(51) Int. Cl. G06F 9/46

(52) U.S. Cl. 718/102

(57) ABSTRACT

Computationally implemented methods and systems include receiving subtask data including one or more subtasks that correspond to at least one portion of at least one task requested by a task requestor, wherein the one or more subtasks are configured to be carried out by two or more discrete interface devices, carrying out the one or more subtasks in an absence of information regarding the at least one task and/or the task requestor, and transmitting result data comprising a result of carrying out the one or more subtasks. In addition to the foregoing, other aspects are described in the claims, drawings, and text.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)). All subject matter of the Related Applications and of any and all parent, grandparent, great-grandparent, etc. applications of the Related Applications is incorporated herein by reference to the extent such subject matter is not inconsistent herewith.

For purposes of the USPTO extra-statutory requirements, the present application constitutes a continuation-in-part of U.S. patent application Ser. No. 13/200,553, entitled ACQUIRING AND TRANSMITTING TASKS AND SUBTASKS TO INTERFACE DEVICES, naming Royce A. Levien; Richard T. Lord; Robert W. Lord; Mark A. Malamud; and John D. Rinaldo, Jr., as inventors, filed Sep. 23, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/200,797, entitled ACQUIRING AND TRANSMITTING TASKS AND SUBTASKS TO INTERFACE DEVICES, naming Royce A. Levien; Richard T. Lord; Robert W. Lord; Mark A. Malamud; and John D. Rinaldo, Jr., as inventors, filed Sep. 30, 2011, which is currently co-pending, or is an application of which a currently co-pending application is entitled to the benefit of the filing date.

For purposes of the USPTO extra-statutory requirements, the present application constitutes a continuation-in-part of United States Patent Application No. To Be Assigned, entitled ACQUIRING, PRESENTING AND TRANSMITTING TASKS AND SUBTASKS TO INTERFACE DEVICES, naming Royce A. Levien; Richard T. Lord; Robert W. Lord; Mark A. Malamud; and John D. Rinaldo, Jr., as inventors, filed Oct. 21, 2011, which is currently co-pending, or is an application of which a currently co-pending application is entitled to the benefit of the filing date.

For purposes of the USPTO extra-statutory requirements, the present application constitutes a continuation-in-part of United States Patent Application No. To Be Assigned, entitled ACQUIRING, PRESENTING AND TRANSMITTING TASKS AND SUBTASKS TO INTERFACE DEVICES, naming Royce A. Levien; Richard T. Lord; Robert W. Lord; Mark A. Malamud; and John D. Rinaldo, Jr., as inventors, filed Oct. 28, 2011, which is currently co-pending, or is an application of which a currently co-pending application is entitled to the benefit of the filing date.

### BACKGROUND

This application is related to using interface devices to collect data.

### SUMMARY

A computationally implemented method includes, but is not limited to receiving subtask data including one or more subtasks that correspond to at least one portion of at least one task requested by a task requestor, and configured to be carried out by two or more discrete interface devices, carrying out the one or more subtasks in an absence of information regarding the at least one task and/or the task requestor, and transmitting result data comprising a result of carrying out the one or more subtasks. In addition to the foregoing, other method aspects are described in the claims, drawings, and text forming a part of the present disclosure.

In one or more various aspects, related systems include but are not limited to circuitry and/or programming for effecting the herein referenced method aspects; the circuitry and/or programming can be virtually any combination of hardware, software, and/or firmware in one or more machines or article of manufacture configured to effect the herein-referenced method aspects depending upon the design choices of the system designer.

A computationally implemented system includes, but is not limited to: means for receiving subtask data including one or more subtasks that correspond to at least one portion of at least one task requested by a task requestor, and configured to be carried out by two or more discrete interface devices, means for carrying out the one or more subtasks in an absence of information regarding the at least one task and/or the task requestor, and means for transmitting result data comprising a result of carrying out the one or more subtasks.

A computationally implemented system includes, but is not limited to: circuitry for receiving subtask data including one or more subtasks that correspond to at least one portion of at least one task requested by a task requestor, and configured to be carried out by two or more discrete interface devices, circuitry for carrying out the one or more subtasks in an absence of information regarding the at least one task and/or the task requestor, and circuitry for transmitting result data comprising a result of carrying out the one or more subtasks.

A computer program product comprising an article of manufacture bears instructions, including but not limited to: one or more instructions for receiving subtask data including one or more subtasks that correspond to at least one portion of at least one task requested by a task requestor, and configured to be carried out by two or more discrete interface devices, one or more instructions for carrying out the one or more subtasks in an absence of information regarding the at least one task and/or the task requestor, and one or more instructions for transmitting result data comprising a result of carrying out the one or more subtasks.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1, including FIGS. 1A and 1B, shows a high-level block diagram of an interface device operating in an exemplary environment 100, according to an embodiment.

FIG. 2A, including FIGS. 2A1 through 2A3, shows a particular perspective of the task requestor task portion subtask data receiving module 52 of the interface device 20 of environment 100 of FIG. 1.

FIG. 2B, including FIGS. 2B1 through 2B7, shows a particular perspective of the absent task and/or task requestor information subtask execution module 54 of the interface device 20 of environment 100 of FIG. 1.

FIG. 3 shows a particular perspective of the subtask result data transmitting module 56 of the interface device 20 of environment 100 of FIG. 1.

FIG. 4 is a high-level logic flowchart of a process, e.g., operational flow 400, according to an embodiment.

FIG. 5A is a high-level logic flowchart of a process depicting alternate implementations of a receiving subtask data operation 402 of FIG. 4.

FIG. 5B is a high-level logic flowchart of a process depicting alternate implementations of a receiving subtask data operation 402 of FIG. 4.

FIG. 5C is a high-level logic flowchart of a process depicting alternate implementations of a receiving subtask data operation 402 of FIG. 4.

FIG. 5D is a high-level logic flowchart of a process depicting alternate implementations of a receiving subtask data operation 402 of FIG. 4.

FIG. 6A is a high-level logic flowchart of a process depicting alternate implementations of a carrying out the one or more subtasks operation 404 of FIG. 4.

FIG. 6B is a high-level logic flowchart of a process depicting alternate implementations of a carrying out the one or more subtasks operation 404 of FIG. 4.

FIG. 6C is a high-level logic flowchart of a process depicting alternate implementations of a carrying out the one or more subtasks operation 404 of FIG. 4.

FIG. 6D is a high-level logic flowchart of a process depicting alternate implementations of a carrying out the one or more subtasks operation 404 of FIG. 4.

FIG. 6E is a high-level logic flowchart of a process depicting alternate implementations of a presenting one or more representations corresponding to the one or more subtasks operation 404 of FIG. 4.

FIG. 6F is a high-level logic flowchart of a process depicting alternate implementations of a carrying out the one or more subtasks operation 404 of FIG. 4.

FIG. 6G is a high-level logic flowchart of a process depicting alternate implementations of a carrying out the one or more subtasks operation 404 of FIG. 4.

FIG. 6H is a high-level logic flowchart of a process depicting alternate implementations of a carrying out the one or more subtasks operation 404 of FIG. 4.

FIG. 7 is a high-level logic flowchart of a process depicting alternate implementations of a transmitting result data operation 406 of FIG. 4.

### DETAILED DESCRIPTION

In the following detailed description, reference is made to the accompanying drawings, which form a part hereof. In the drawings, similar symbols typically identify similar or identical components or items, unless context dictates otherwise. The illustrative embodiments described in the detailed description, drawings, and claims are not meant to be limiting. Other embodiments may be utilized, and other changes may be made, without departing from the spirit or scope of the subject matter presented here.

In addition, the promulgation of portable electronic devices, each having their own set of unique sensors and detectors, has been widespread. Currently, there are very few populated areas of developed countries which do not contain a large number of portable computing devices at any given time. These portable computing devices are constantly collecting data, and capable of collecting data, which is not stored in any repository or transmitted to any device which may use such data. Thus, such data, and opportunity to collect data, may be lost.

In accordance with various embodiments, computationally implemented methods, systems, and articles of manufacture are provided for receiving subtask data including one or more subtasks that correspond to at least one portion of at least one task requested by a task requestor, and configured to be carried out by two or more discrete interface devices, carrying out the one or more subtasks in an absence of information regarding the at least one task and/or the task requestor, and transmitting result data comprising a result of carrying out the one or more subtasks. In various embodiments, such computationally implemented methods, systems, and articles of manufacture may be implemented at the interface device.

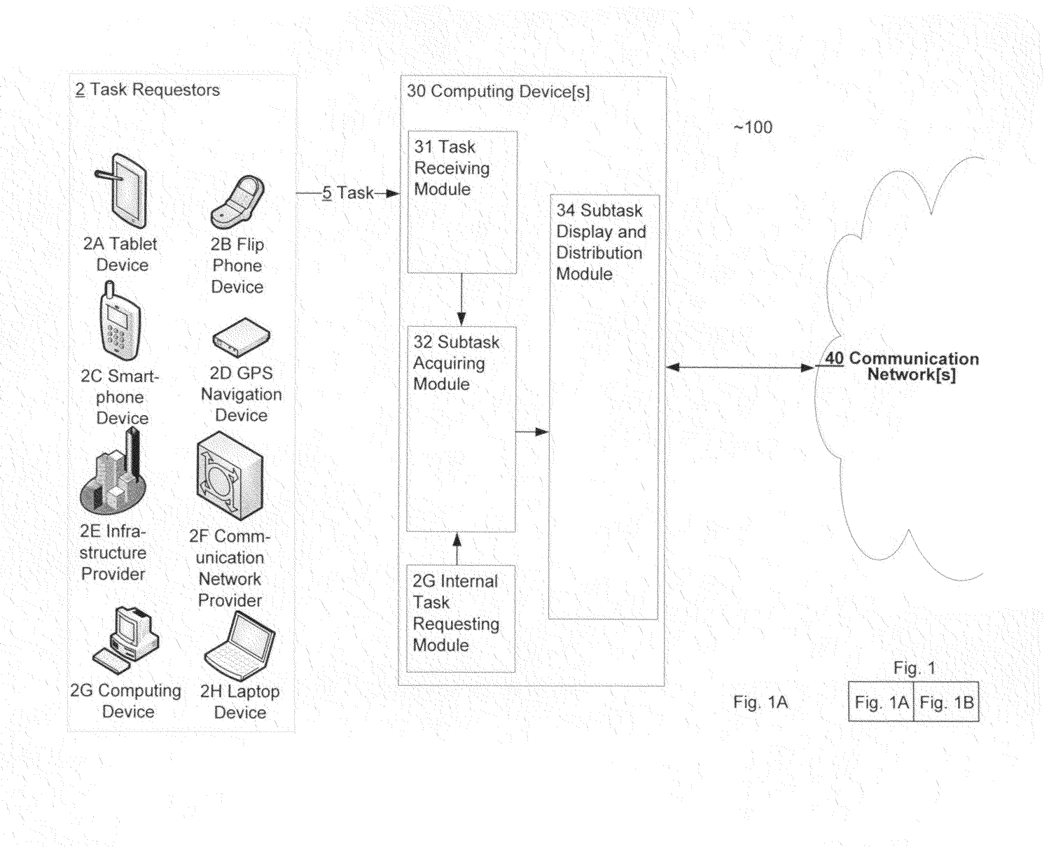

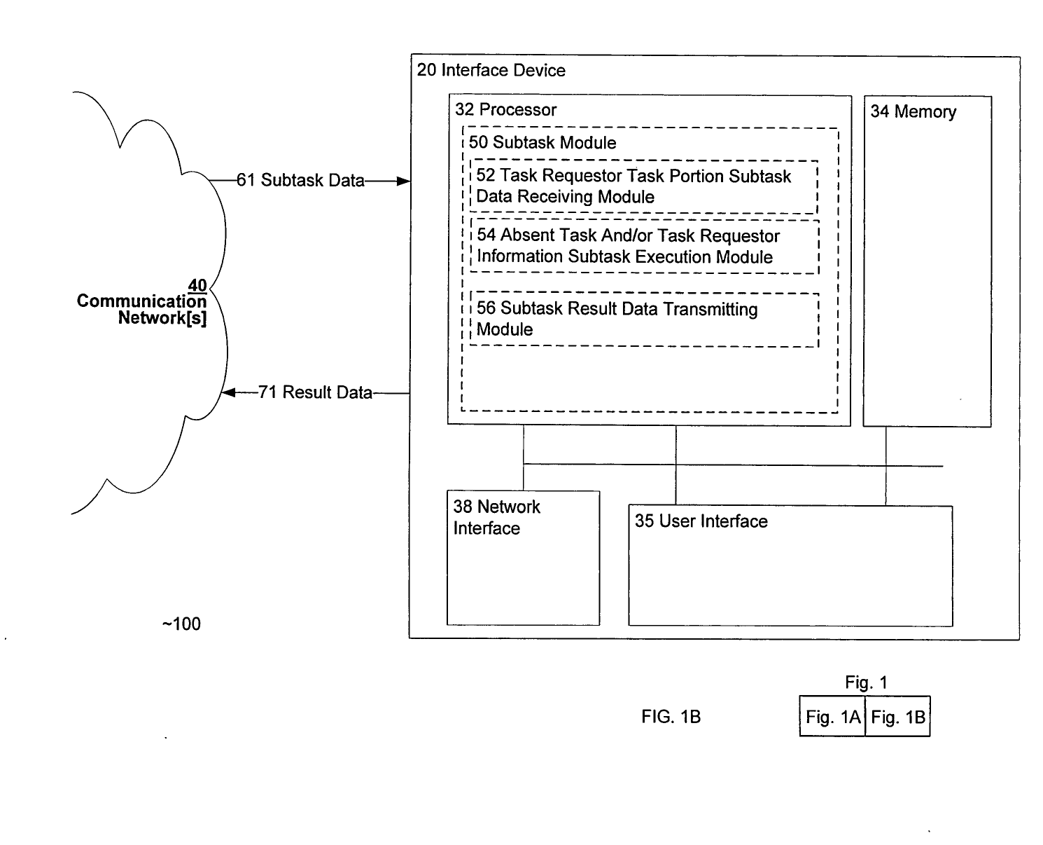

Referring now to FIG. 1, FIG. 1 illustrates an interface device 20 in an exemplary environment 100. As will be described in more detail herein, the interface device 20 may employ the computationally implemented methods, systems, and articles of manufacture in accordance with various embodiments. The interface device 20, in various embodiments, may be endowed with logic that is designed to receive subtask data including one or more subtasks that correspond to at least one portion of at least one task requested by a task requestor, wherein the one or more subtasks are configured to be carried out by two or more discrete interface devices, carry out the one or more subtasks in an absence of information regarding the at least one task and/or the task requestor, and transmit result data comprising a result of carrying out the one or more subtasks.

Note that in the following description, the character “*” represents a wildcard. Thus, references to, for example, task requestors 2* of FIG. 1 may be in reference to tablet device 2A, flip phone device 2B, smartphone device 2C, GPS navigation device 2D, infrastructure provider 2E, communication network provider 2F, computing device 2G, laptop device 2H, and internal task requesting module 2G, which may be part of computing device 30, but for the purposes of the interface devices described herein, is not distinguishable from the other task requestors 2*. FIG. 1 illustrates a number of task requestors 2*. For example, FIG. 1 illustrates task requestor 2A as a tablet, task requestor 2B as a flip phone, and task requestor 2C as a smartphone device. These drawings are meant to be illustrative only, and should not be construed as limiting the definition of task requestors 2*, which can be any device with computing functionality.

Within the context of this application, “discrete interface device” is defined as an “interface device capable of operating or being operated independently of other discrete interface devices.” The discrete interface devices may be completely unaware of each other, and are not necessarily the same type. For example, discrete interface devices 20*, which will be described in more detail herein, include but are not limited to laptop computers, computer tablets, digital music players, personal navigation systems, net books, smart phones, PDAs, digital still cameras, digital video cameras, vehicle assistance systems, and handheld game devices. For the purposes of this application, the type of interface device is not important, except that it can communicate with a communications network, and that it has device characteristics and status, as will be described in more detail herein.

Referring again to the exemplary environment 100 of FIG. 1, in various embodiments, the task requestors 2 may send a task, e.g., task 5 to computing device 30. Computing device 30 may be any type of device that has a processor and may communicate with other devices. Although FIG. 1 illustrates computing device 30 as a single unit, computing device 30 may be implemented as multiple computers, servers, or other devices, operating singularly or in parallel, connected locally or via any type of network. As shown in FIG. 1, computing device 30 is illustrated as having several modules which will be discussed in more detail herein, e.g., a task receiving module 31, a subtask acquiring module 32, a subtask display and distribution module 34, and optionally, an internal task requesting module 2G. Specifically, these particular modules may be implemented across different networks and systems, and may be partially or wholly unaware of each other, except for the need to transmit data as indicated by the arrows within computing device 30.

A task 5 sent from a task requestor 2 may be received by task receiving module 31. Task receiving module 31 then may pass the task to subtask acquiring module 32, where the task is separated into component subtasks. Tasks may be separated into component subtasks using any known type of processing, including neural net processing, natural language processing, machine learning, logic-based processing, and knowledge-based processing. For example, a received task may be “Take a 360 degree picture of the Eiffel Tower.” The subtask acquiring module 32 may process the language of this received task, and separate it into components of “take a picture of the Eiffel Tower.” Either by consulting machine archives or by predicting how many pictures must be combined to make a 360 degree picture, the system may determine, for example, that 25 pictures of the Eiffel Tower are needed. These twenty-five “take a picture of the Eiffel Tower” subtasks thus are created. The preceding example is merely a simple example of how a computing device 30 may process tasks into subtasks. Other methods, which may be substantially more complex, may be used in this process, but are not discussed in detail here.

Subtask acquiring module 32 may then pass the acquired subtasks to a subtask display and distribution module. Subtask display and distribution module may distribute the subtasks to at least two interface devices 20. The subtasks are designed to be carried out by two or more discrete interface devices 20. Nevertheless, for ease of illustration, only one discrete interface device 20 is shown in FIG. 1. Discrete interface device 20 and subtask display and distribution module 34 communicate via a communication network 40.

The computing device 30 may communicate via a communications network 40. In various embodiments, the communication network 40 may include one or more of a local area network (LAN), a wide area network (WAN), a metropolitan area network (MAN), a wireless local area network (WLAN), a personal area network (PAN), a Worldwide Interoperability for Microwave Access (WiMAX), public switched telephone network (PTSN), a general packet radio service (GPRS) network, a cellular network, and so forth. The communication networks 40 may be wired, wireless, or a combination of wired and wireless networks. It is noted that “communication network” here refers to communication networks, which may or may not interact with each other.

It is noted that discrete interface device 20 communicates only with subtask display and distribution module 34. Discrete interface device 20 is not provided with any information regarding the task requestor 2, or even the task 5 received by the task receiving module prior to being broken into component subtasks. This is true even when, as with task requestor 2G, the task request may be internal to computing device 30. Regardless of the situation or orientation of the task requestors 2, or whether subtask acquiring module and task receiving module are internal or external to computing device 30, interface device 20 receives only the subtask information from the subtask display and distribution module 34 of the computing device 30.

Specifically, as shown in exemplary environment 100 of FIG. 1, interface device 20 may receive subtask data 61 from the communication network. In various embodiments, subtask data 61 may require processing or decision-making by the interface device 20. In some embodiments, subtask data 61 may be explicit instructions to carry out a specific subtask. In other embodiments, subtask data 61 may require some processing by the interface device 20. In all embodiments, however, only enough data to complete a subtask is received by the interface device 20.

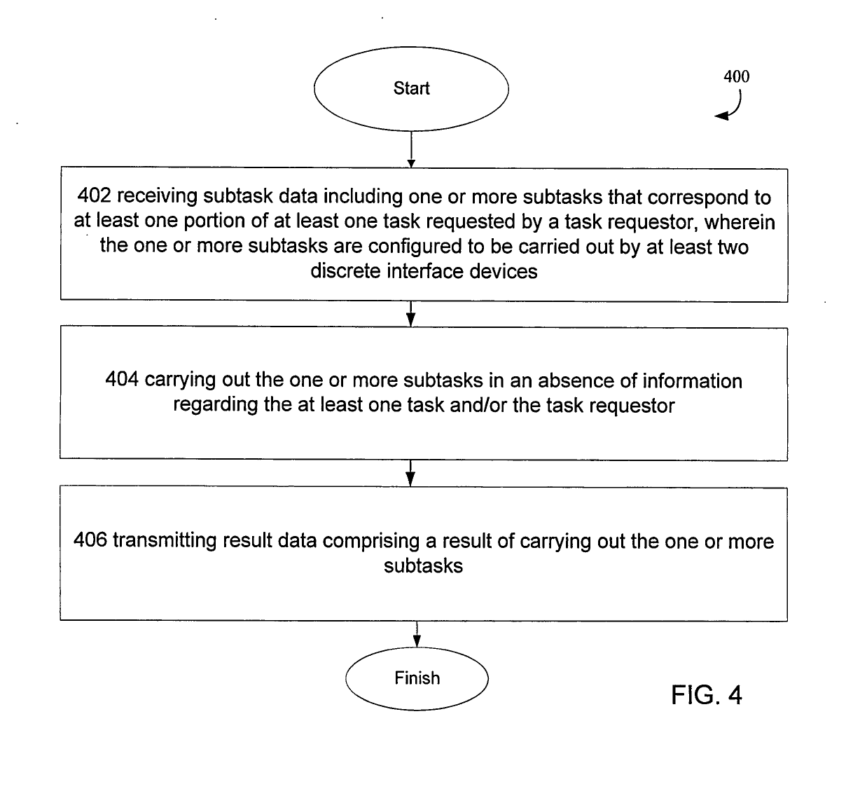

In some embodiments, the subtask data 61 is executed by the interface device 20 automatically to carry out the subtask. In some embodiments, the subtask data 61 may be instructions for displaying commands on a user interface 35 of the interface device 20, for a user to carry out to complete the subtask. It is noted that, in some embodiments, a “user” is a representation of a person operating an electronic device, e.g., a portable computing device, or a non-portable computing device, e.g., a desktop computer, an information kiosk, or a terminal, e.g., an ATM terminal. In other embodiments, however, a user is merely a representation of a machine or person making a request. For example, a user may be an automated program that carries out tasks. As will be further described with reference to FIG. 4, the operational flow 400 may be executed in a variety of different ways in various alternative implementations, which will be discussed in more detail herein.

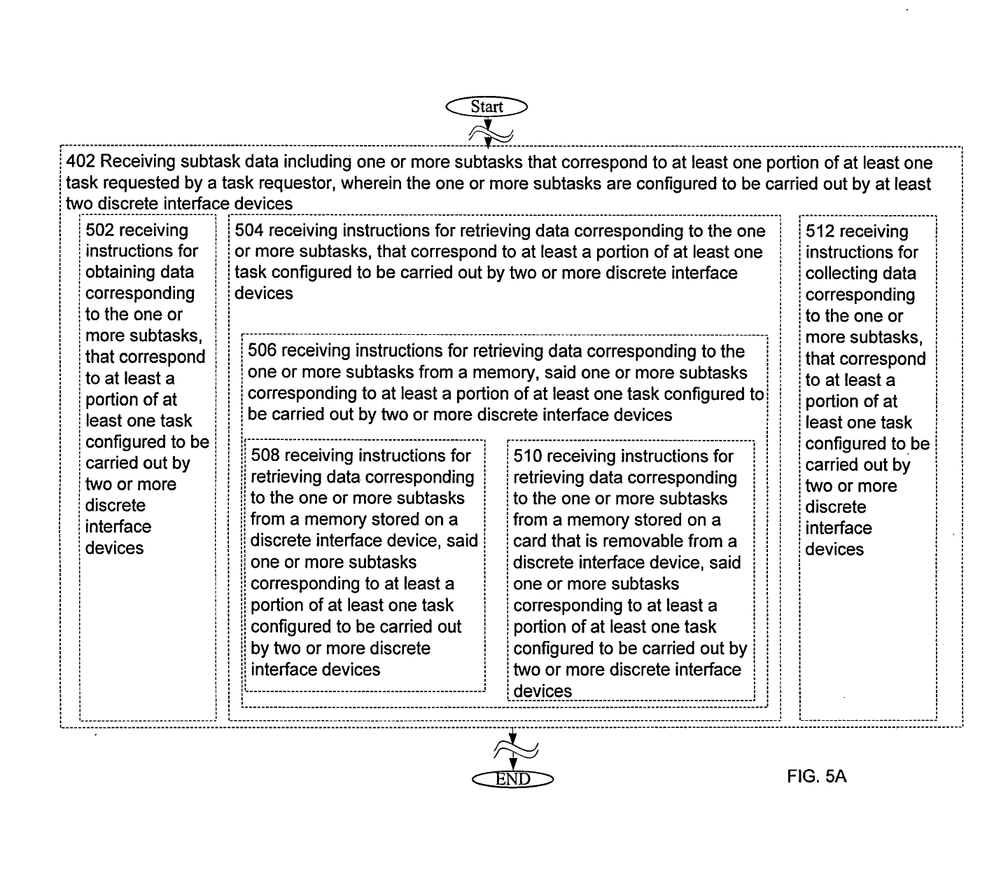

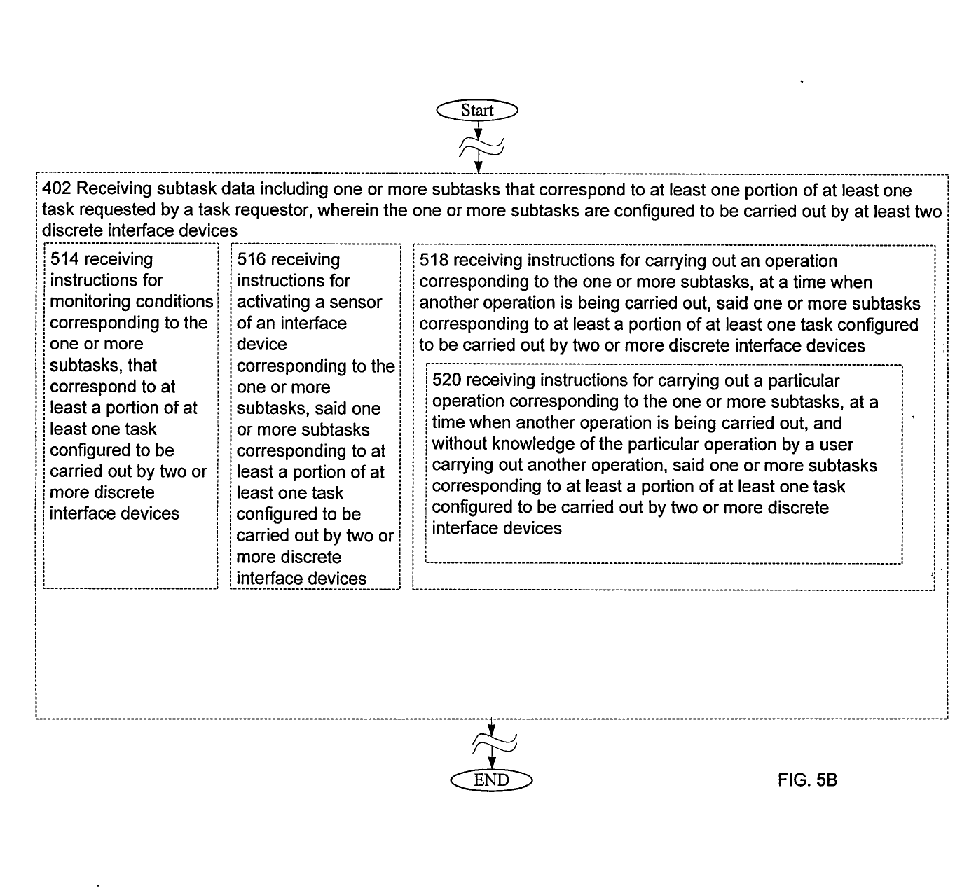

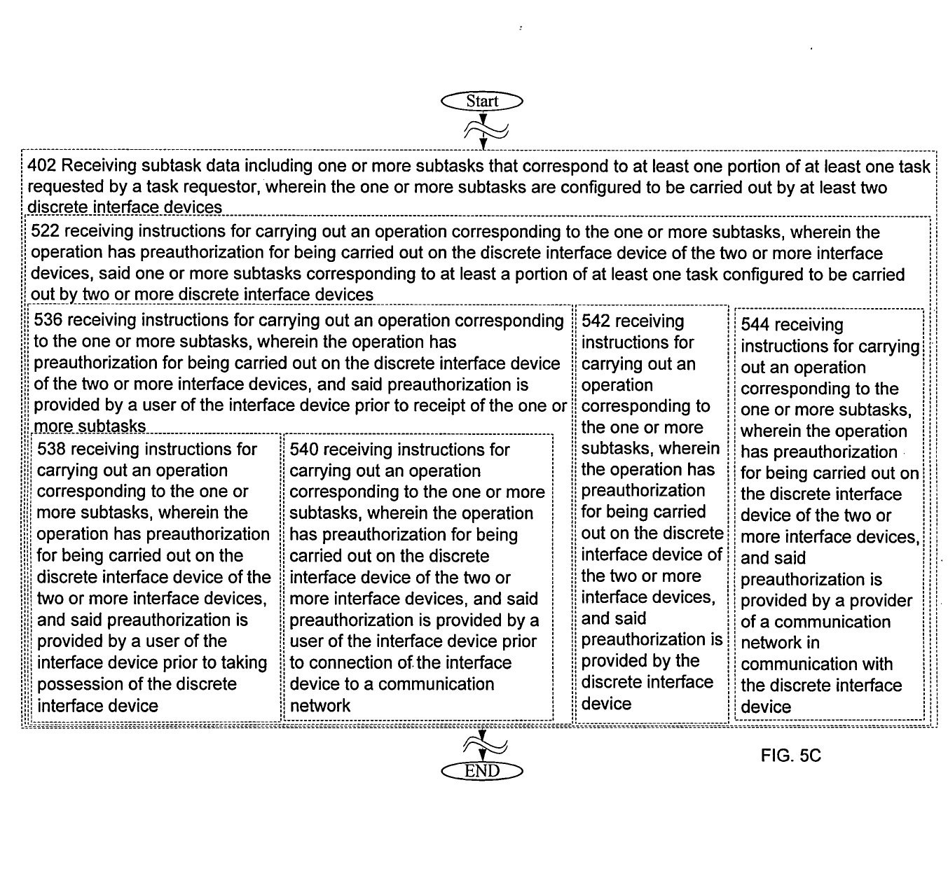

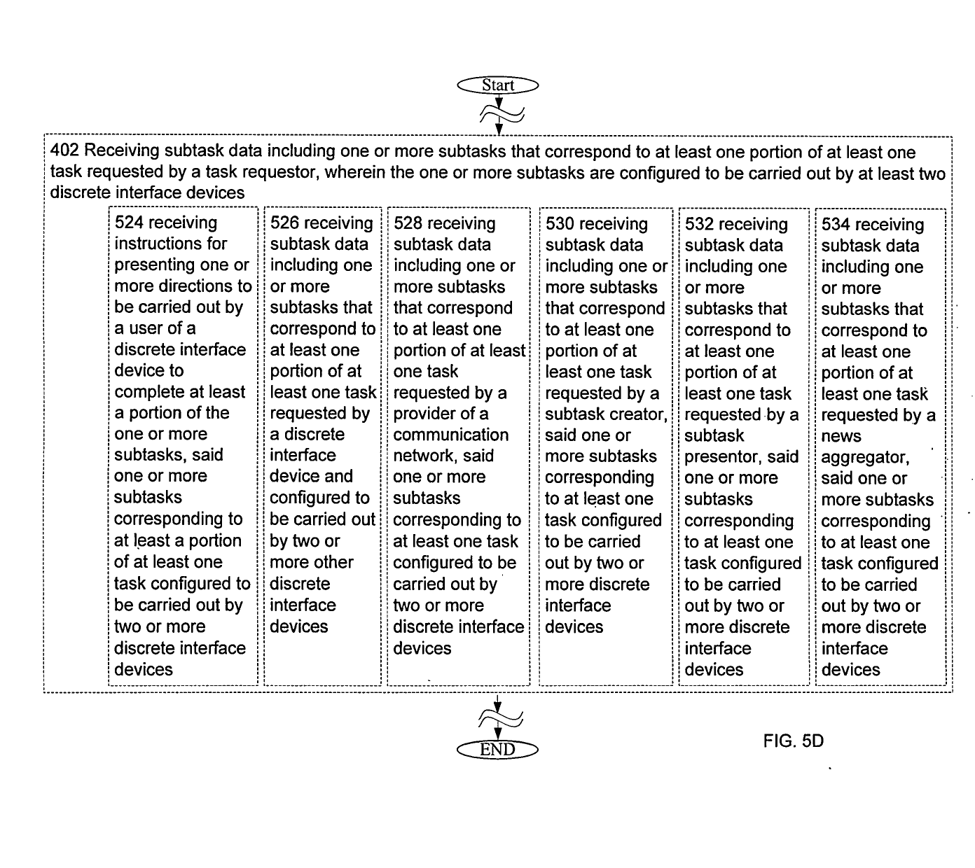

Referring again to the example environment 100 of FIG. 1, in various embodiments, the interface device 20 may comprise, among other elements, a processor 32, a memory 34, a network interface 38, and a user interface 35. Processor 32 may include one or more microprocessors, Central Processing Units (“CPU”), a Graphics Processing Units (“GPU”), Physics Processing Units, Digital Signal Processors, Network Processors, Floating Point Processors, and the like. In some embodiments, processor 32 may be a server. In some embodiments, processor 32 may be a distributed-core processor. Although processor 32 is depicted as a single processor that is part of a single computing device 30, in some embodiments, processor 32 may be multiple processors distributed over one or many computing devices 30, which may or may not be configured to work together. Processor 32 is illustrated as being configured to execute computer readable instructions in order to execute one or more operations described above, and as illustrated in FIGS. 5A-5D, 6A-6H, and 7. In some embodiments, processor 32 is designed to be configured to operate as the subtask module 50 which may include task requestor task portion subtask data receiving module 52, absent task and/or task requestor information subtask execution module 54, and subtask result data transmitting module 56.

As described above, the computing device 30 may comprise a memory 34. In some embodiments, memory 34 may comprise of one or more of one or more mass storage devices, read-only memory (ROM), programmable read-only memory (PROM), erasable programmable read-only memory (EPROM), cache memory such as random access memory (RAM), flash memory, synchronous random access memory (SRAM), dynamic random access memory (DRAM), and/or other types of memory devices. In some embodiments, memory 34 may be located at a single network site. In other embodiments, memory 34 may be located at multiple network sites, including sites that are distant from each other.

As described above, and with reference to FIG. 1, computing device 30 may include a user interface 35. The user interface may be implemented in hardware or software, or both, and may include various input and output devices to allow an operator of a computing device 30 to interact with computing device 30. For example, user interface 35 may include, but is not limited to, an audio display, a video display, a microphone, a camera, a keyboard, a mouse, a joystick, a game controller, a touchpad, a handset, or any other device that allows interaction between a computing device and a user.

Referring again to FIG. 1, interface device 20 may include a network interface 38. Communications between the interface device 20 and the communications network 40 may be facilitated by the network interface module 38, which may be implemented as hardware or software, or both, used to interface the interface device 20 with the one or more communication networks 40. In some embodiments, the network interface module 38 may be a Network Interface Card, e.g., a NIC, or an antenna. The specific structure of network interface module 38 depends on the type or types of one or more communication networks 40 that are used. Particular details of this transmission will be discussed in more detail herein.

As shown in FIG. 1, interface 20, upon completion of a subtask received as subtask data 61, may transmit result data 71 via communication network 40 to a computing device 30. The result data may be in various forms, and may be processed by processor 32 prior to transmission to the computing device 30.

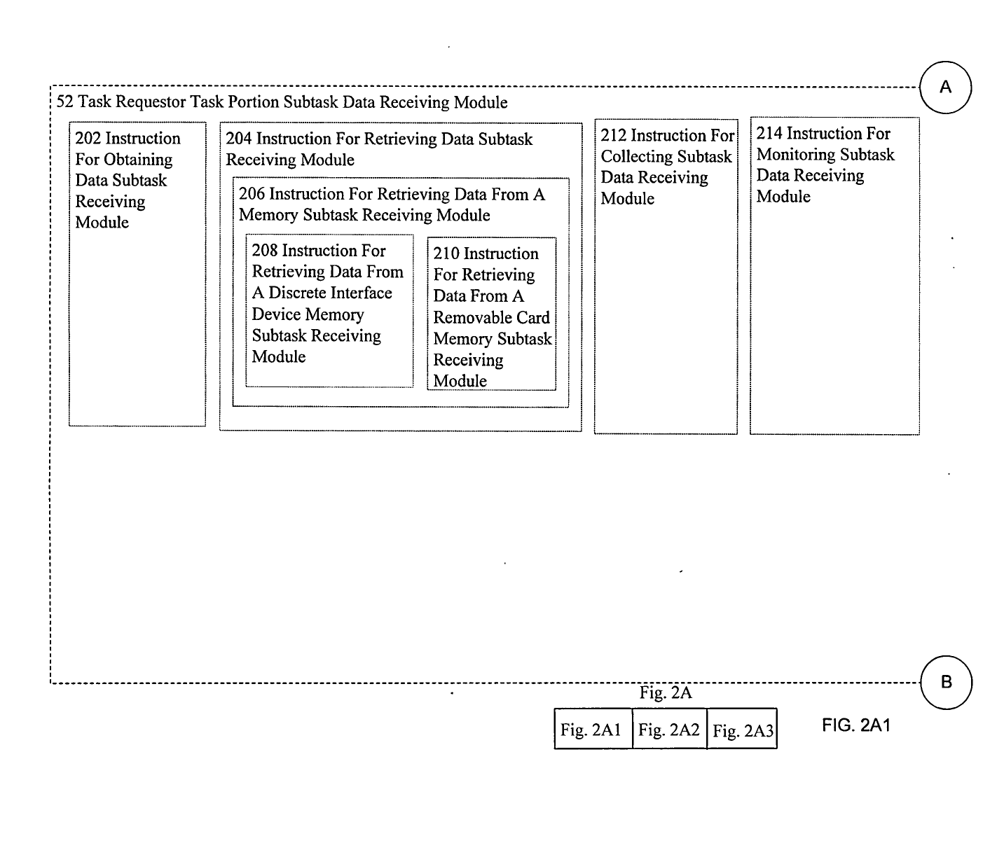

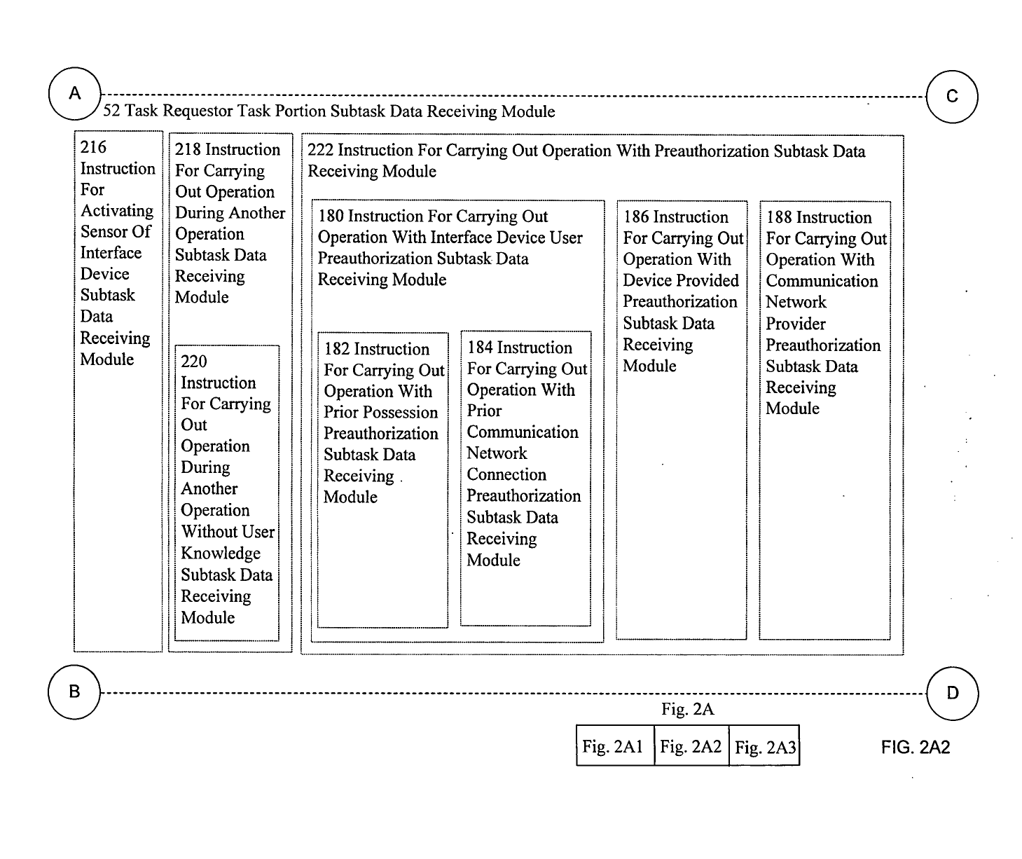

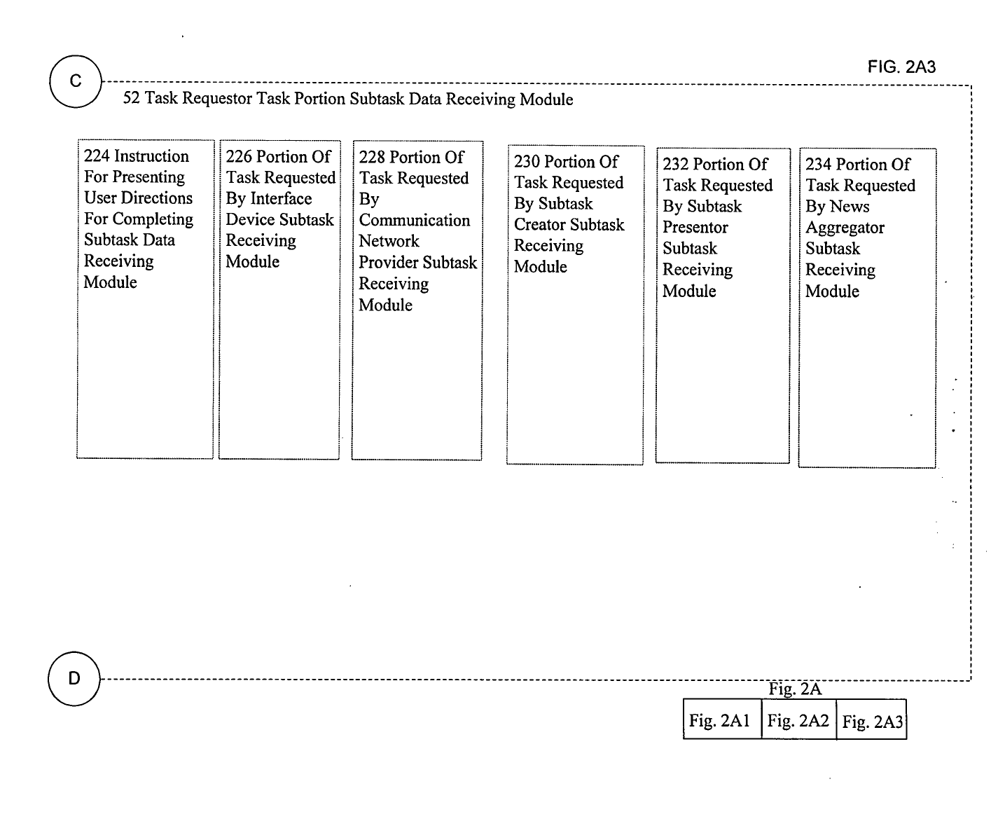

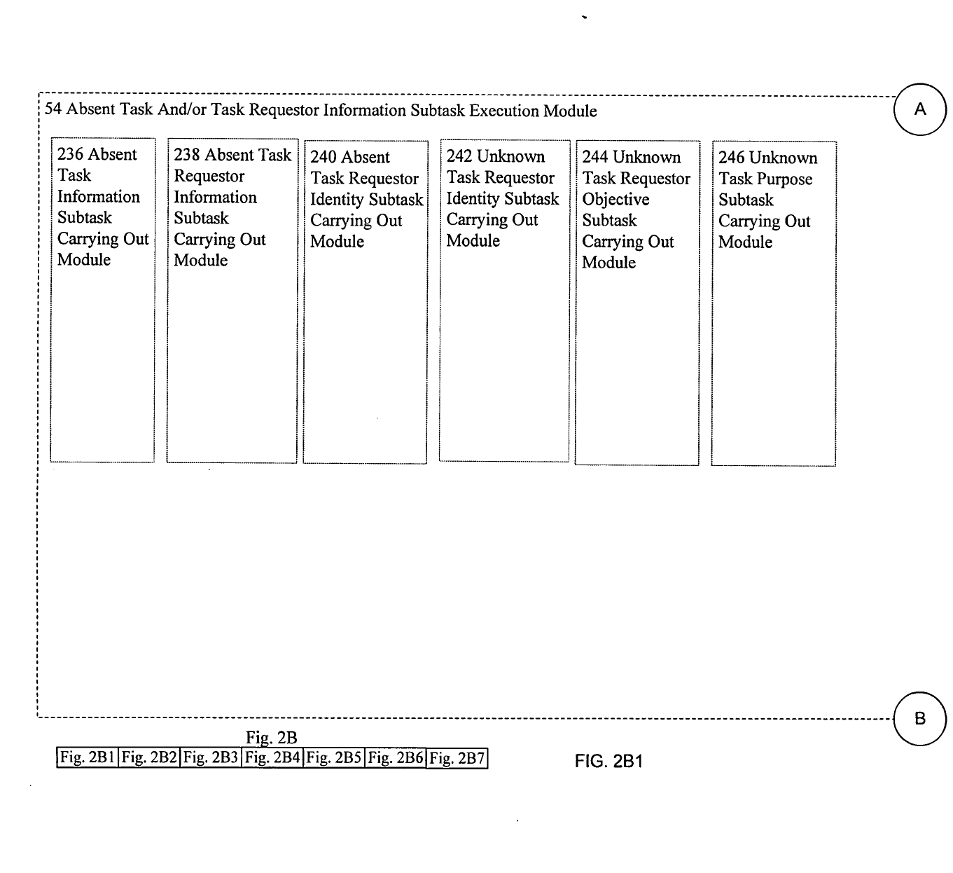

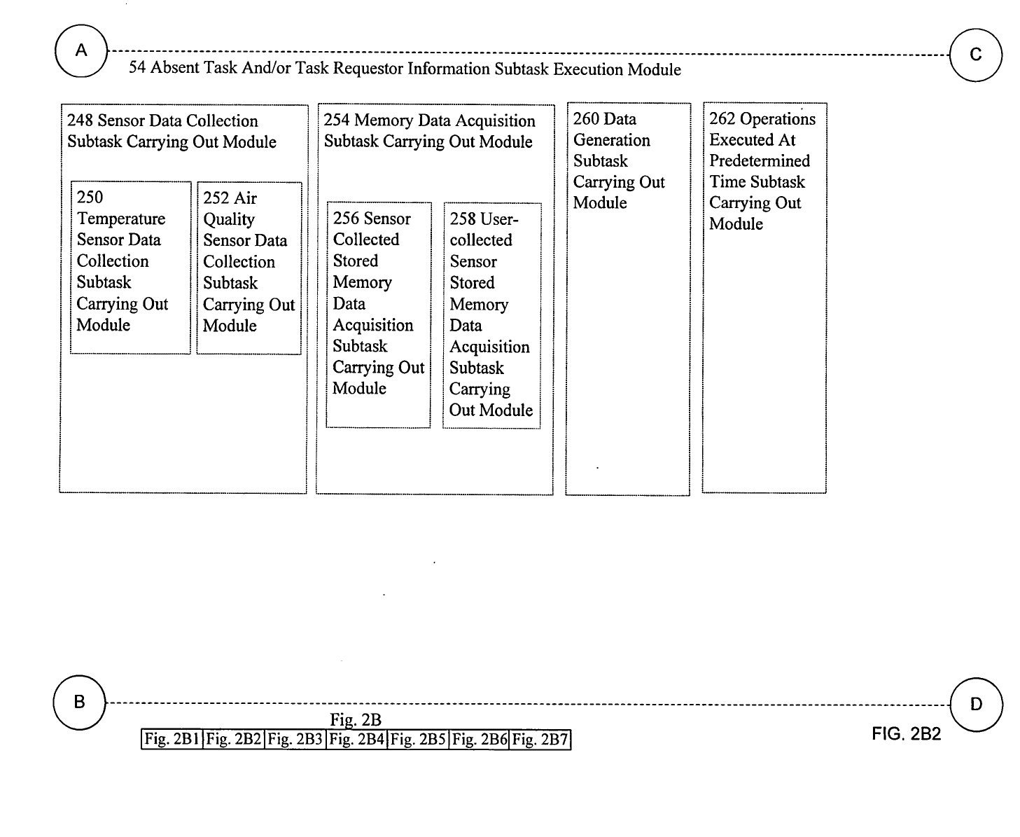

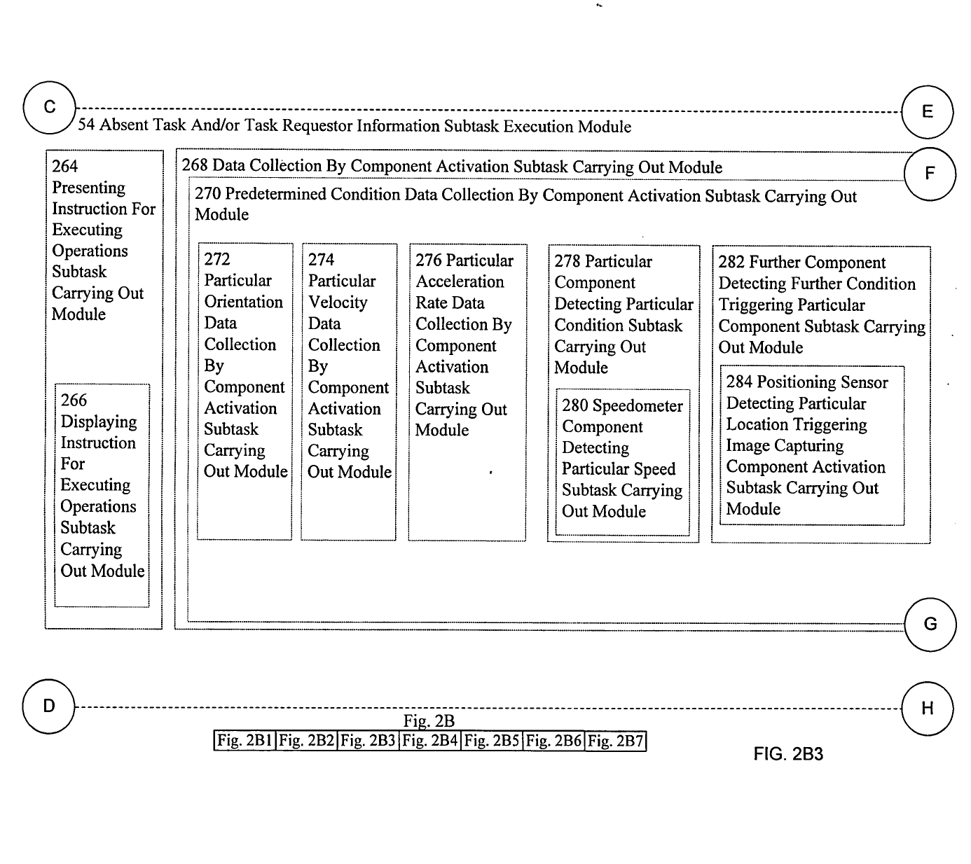

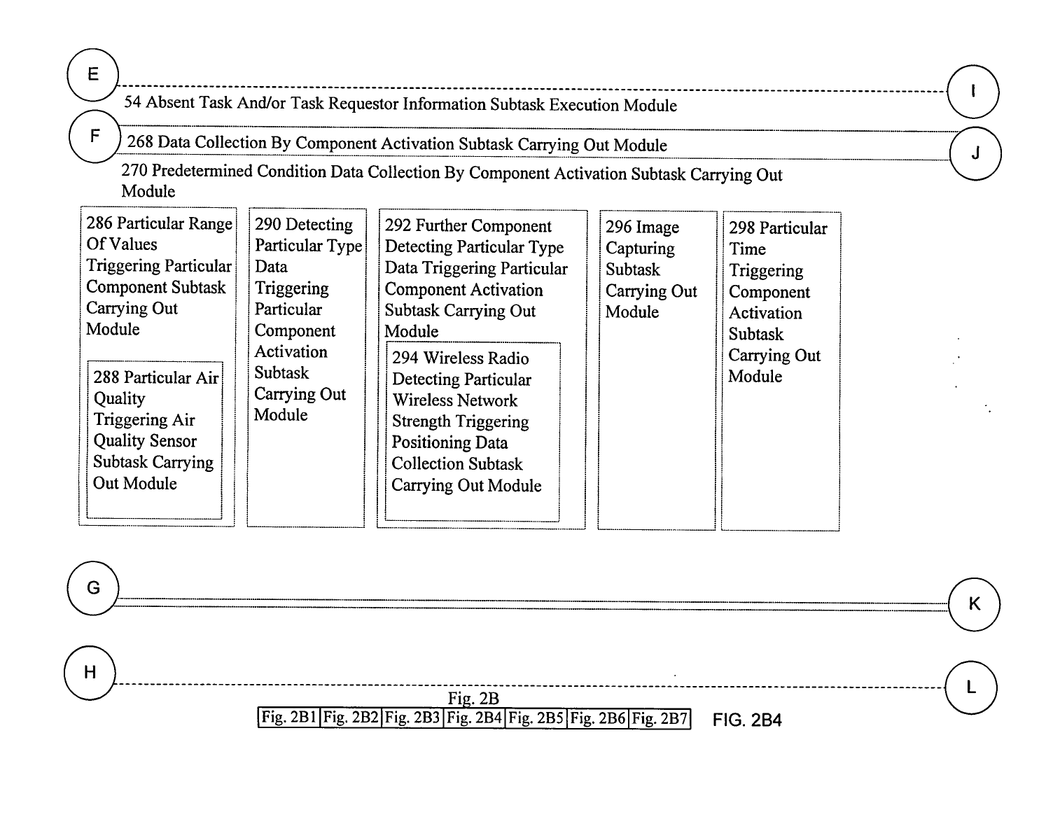

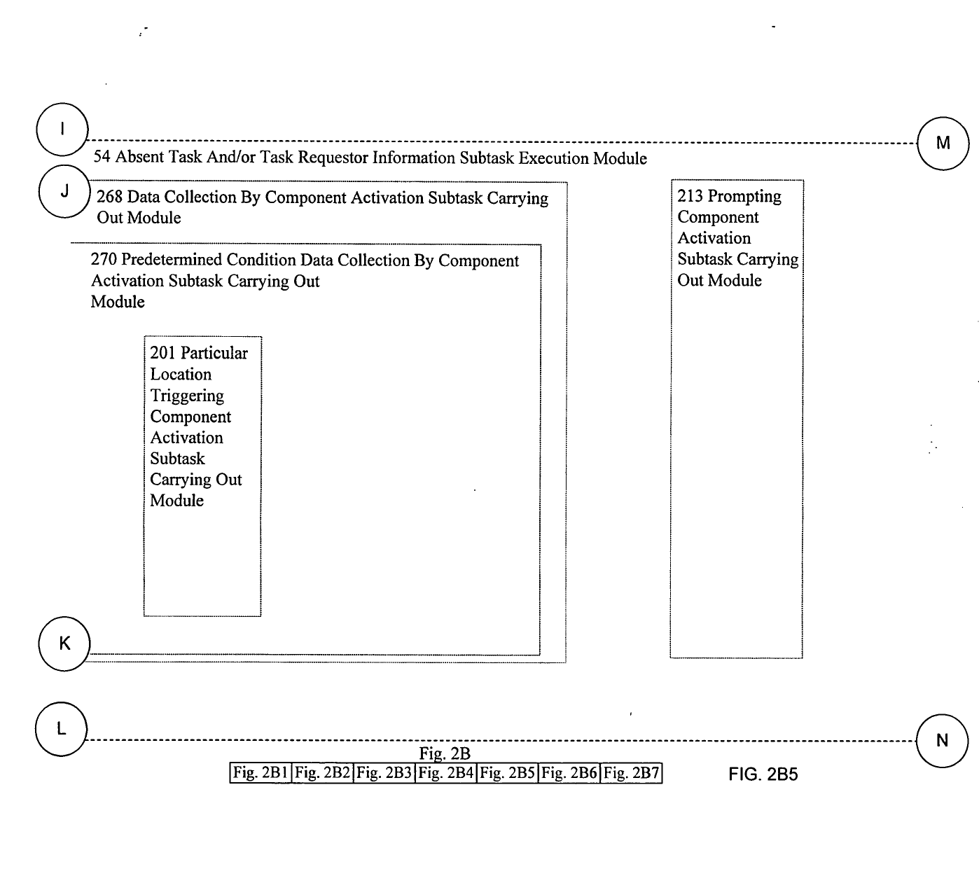

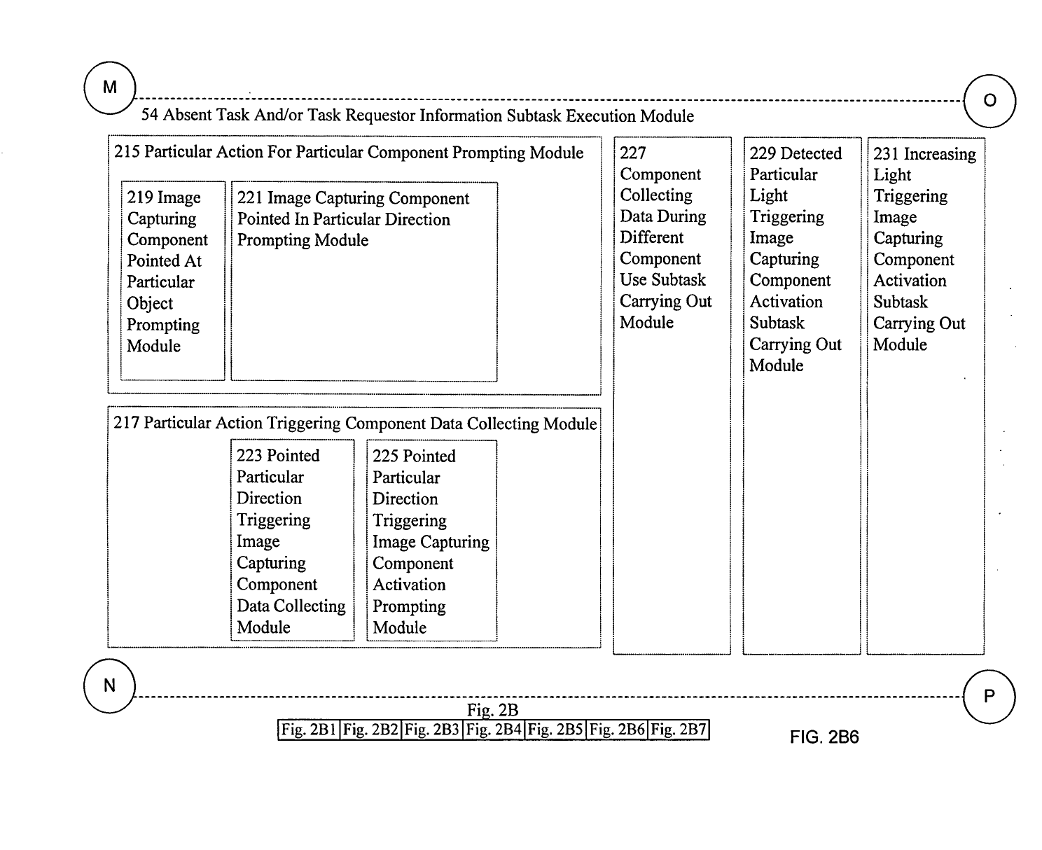

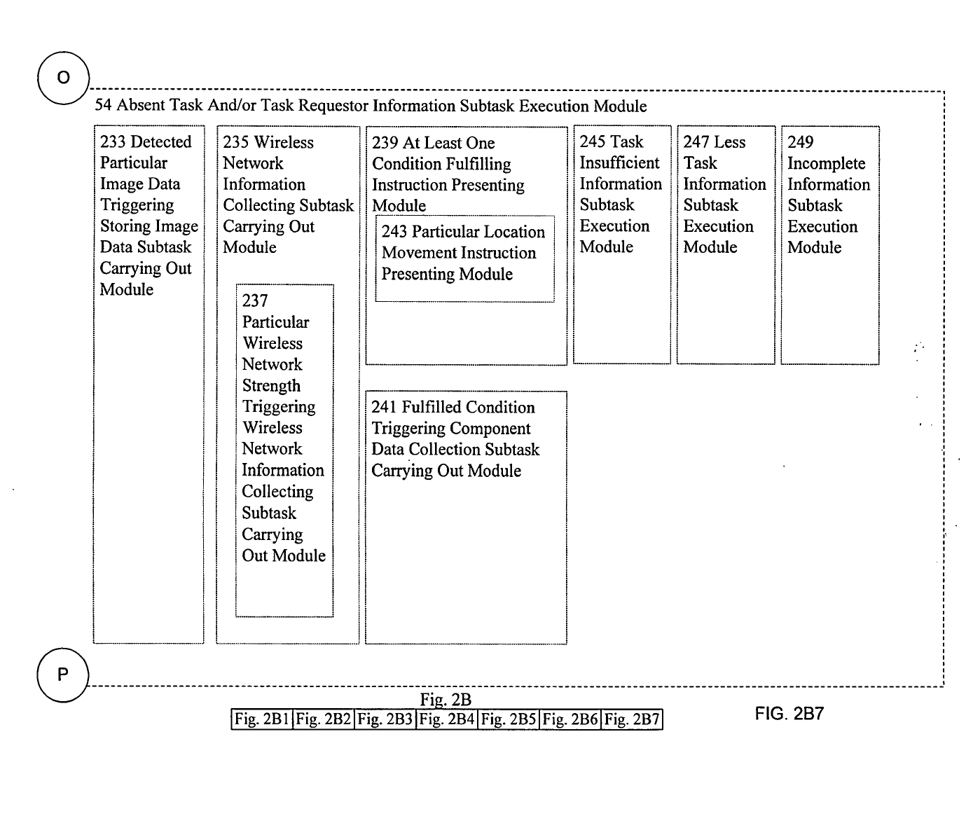

Referring now to FIG. 2A, FIG. 2A illustrates an exemplary implementation of the task requestor task portion subtask data receiving module 52 of the subtask module 50. As illustrated in FIG. 2A, the task requestor task portion subtask data receiving module 52 may include one or more sub-logic modules in various alternative implementations. For example, in some embodiments, module 52 may include an instruction for obtaining data subtask receiving module 202 and an instruction for retrieving data subtask receiving module 204. Module 204, in some embodiments, may further include instruction for retrieving subtask data from a memory receiving module 206 (e.g., which in some embodiments, may further include an instruction for retrieving data from a discrete interface device memory subtask receiving module 208 and an instruction for retrieving data from a removable memory subtask receiving module 210). In some embodiments, module 52 may further include an instruction for collecting subtask data receiving module 212, an instruction for monitoring subtask data receiving module 214, an instruction for activating sensor of interface device subtask data receiving module 216, and an instruction for carrying out operation during another operation subtask data receiving module 218. Module 218 may further include instruction for carrying out operation during another operation without user knowledge subtask data receiving module 220.

In some embodiments, module 52 may include an instruction for carrying out operation with preauthorization subtask data receiving module 222, an instruction for presenting user directions for completing subtask data receiving module 224, a portion of task requested by communication network provider subtask receiving module 226, a portion of task requested by discrete interface device subtask receiving module 228, a portion of task requested by subtask creator subtask receiving module 230, a portion of task requested by subtask presentor subtask receiving module 232, and a portion of task requested by news aggregator subtask receiving module 234.

Referring now to FIG. 2B, FIG. 2B illustrates an exemplary implementation of the absent task and/or task requestor information subtask execution module 54. In some embodiments, module 54 may include absent task information subtask carrying out module 236, absent task requestor information subtask carrying out module 238, absent task requestor identity subtask carrying out module 240, unknown task requestor identity subtask carrying out module 242, unknown task requestor objective subtask carrying out module 244, unknown task purpose subtask carrying out module 246, sensor data collection subtask carrying out module 248 (e.g., which, in some embodiments, may further include temperature sensor data collection subtask carrying out module 250 and air quality sensor data collection subtask carrying out module 252), and memory data acquisition subtask carrying out module 254 (e.g., which, in some embodiments, may further sensor collected stored include memory data acquisition subtask carrying out module 256 and user-collected sensor stored memory data acquisition subtask carrying out module 258).

In some embodiments, module 54 may include data generation subtask carrying out module 260, operations executed at predetermined time subtask carrying out module 262, presenting instruction for executing operations subtask carrying out module 264 (e.g., which, in some embodiments, may further include displaying instruction for executing operations subtask carrying out module 266), and data collection by component activation subtask carrying out module 268 (e.g., which in some embodiments, may include predetermined condition data collection by component activation subtask carrying out module 270). In some embodiments, module 270 may include particular orientation data collection by component activation subtask carrying out module 272, particular velocity data collection by component activation subtask carrying out module 274, particular acceleration rate data collection by component activation subtask carrying out module 276, particular component detecting particular condition subtask carrying out module 278 (e.g., which, in some embodiments, may further include speedometer component detecting particular speed subtask carrying out module 280), and further component detecting further condition triggering particular component subtask carrying out module 282 (e.g., which, in some embodiments, may include positioning sensor detecting particular location triggering camera activation subtask carrying out module 284).

In some embodiments, module 270 may include particular range of values triggering particular component subtask carrying out module 286 (e.g., which, in some embodiments, may include particular air quality triggering air quality sensor subtask carrying out module 288), detecting particular type data triggering particular component activation subtask carrying out module 290, further component detecting particular type data triggering particular component activation subtask carrying out module 292 (e.g., which, in some embodiments may include wireless radio detecting particular wireless network strength triggering positioning data collection subtask carrying out module 294), image capturing subtask carrying out module 296, particular time triggering component activation subtask carrying out module 298, and particular location triggering component activation subtask carrying out module 201.

In some embodiments, module 54 may include prompting component activation subtask carrying out module 213, particular action for particular component prompting module 215 (e.g., which in some embodiments, may include image capturing component pointed at particular object prompting module 219 and image capturing component pointed in particular direction prompting module 221), particular action triggering component data collecting module 217 (e.g., which in some embodiments, may include pointed particular direction image capturing component data collecting module 223 and pointed particular direction triggering image capturing component activation prompting module 225), component collecting data during different component use subtask carrying out module 227, detected particular light triggering image capturing component activation subtask carrying out module 229, and increasing light triggering image capturing component activation subtask carrying out module 231.

In some embodiments, module 54 may include detected particular image data triggering storing image data subtask carrying out module 233, wireless network information collecting subtask carrying out module 235 (e.g., which, in some embodiments, may include particular wireless network strength triggering wireless network information collecting subtask carrying out module), at least one condition fulfilling instruction presenting module 239 (e.g., which in some embodiments, may include particular location movement instruction presenting module 243), fulfilled condition triggering component data collection subtask carrying out module 241, image capturing component orientation instruction presenting module 245, and particular orientation triggering image data capturing instruction presenting module 247.

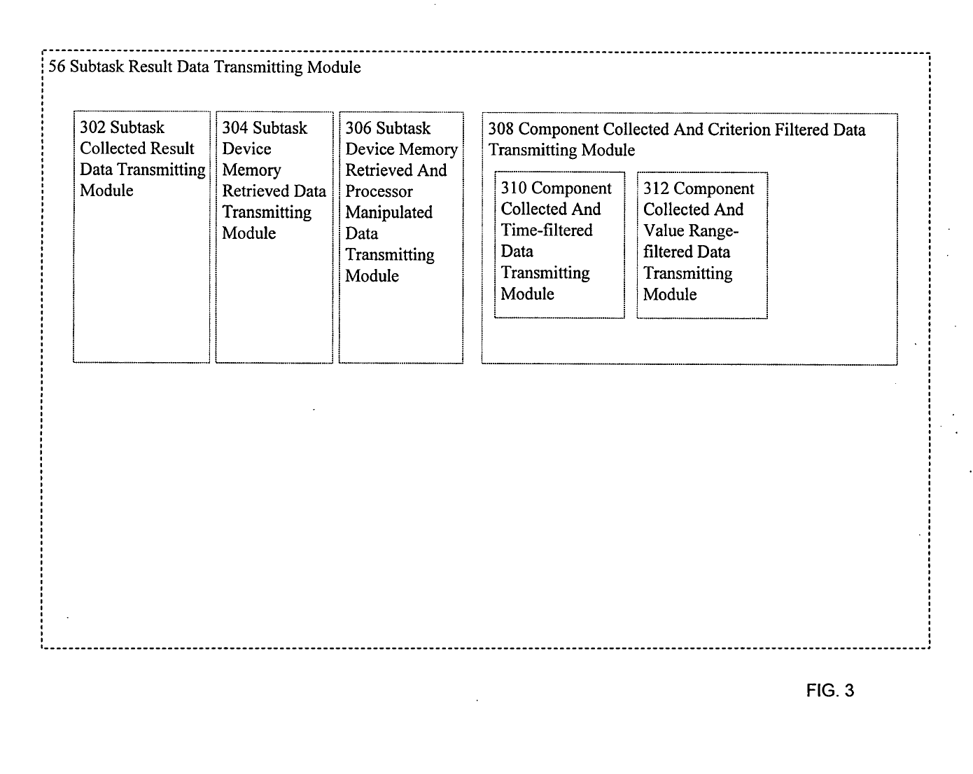

Referring now to FIG. 3, FIG. 3 illustrates an exemplary implementation of the subtask result data transmitting module 56. Module 56 may include subtask collected result data transmitting module 302, subtask device memory retrieved data transmitting module 304, subtask device memory retrieved and processor manipulated data transmitting module 306, and component collected and criterion filtered data transmitting module 308. In some embodiments, criterion filtered data transmitting module 308 may further include component collected and time-filtered data transmitting module 310, and component-collected and value range-filtered data transmitting module 312.

A more detailed discussion related interface device 20 of FIG. 1 will now be provided with respect to the processes and operations to be described herein. FIG. 4 illustrates an operational flow 400 representing example operations for, among other methods, receiving subtask data including one or more subtasks that correspond to at least one portion of at least one task requested by a task requestor, and configured to be carried out by two or more discrete interface devices, carrying out the one or more subtasks in an absence of information regarding the at least one task and/or the task requestor, and transmitting result data comprising a result of carrying out the one or more subtasks. In FIG. 4 and in the following figures that include various examples of operational flows, discussions and explanations will be provided with respect to the exemplary environment 100 as described above and as illustrated in FIG. 1, and with respect to other examples (e.g., as provided in FIGS. 2A, 2B, and 3) and contexts. It should be understood that the operational flows may be executed in a number of other environments and contexts, and/or in modified versions of the systems shown in FIGS. 2A, 2B, and 3. Although the various operational flows are presented in the sequence(s) illustrated, it should be understood that the various operations may be performed in other orders other than those which are illustrated, or may be performed concurrently.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Following are a series of flowcharts depicting implementations. For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

Further, in FIG. 4 and in the figures to follow thereafter, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently. Still further, these operations illustrated in FIG. 4 as well as the other operations to be described herein may be performed by at least one of a machine, an article of manufacture, or a composition of matter.

It is noted that, for the examples set forth in this application, the tasks and subtasks are commonly represented by short strings of text. This representation is merely for ease of explanation and illustration, and should not be considered as defining the format of tasks and subtasks. Rather, in various embodiments, the tasks and subtasks may be stored and represented in any data format or structure, including numbers, strings, Booleans, classes, methods, complex data structures, and the like.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

With reference now to FIG. 4, FIG. 4 shows operational flow 400. Operational flow 400 depicts operation 402, which depicts receiving subtask data including one or more subtasks that correspond to at least one portion of at least one task requested by a task requestor, and configured to be carried out by two or more discrete interface devices. For example, referring to FIG. 1, FIG. 1 shows task requestor task portion subtask data receiving module 52 receiving subtask data including one or more subtasks (e.g., “determine the view of the London Philharmonic from the seat location at the Seattle Theater”) that correspond to at least one portion of at least one task (e.g., “determine which seats at the Seattle theater have an unobstructed view of the #2 cellist of the London Philharmonic”) requested by a task requestor (e.g., a person sitting at home with tickets to the London Philharmonic at the Seattle Theater for the following night), wherein the one or more subtasks (e.g., “determine the view of the London Philharmonic from the seat location at the Seattle Theater”) are configured to be carried out by two or more discrete interface devices (e.g., an iPhone of a person sitting in a lower-deck seat at Seattle Theater, and a Canon EOS Rebel of a person taking pictures from a balcony seat at the Seattle Theater).

Referring again to FIG. 4, operational flow 400 depicts operation 404, which depicts carrying out the one or more subtasks in an absence of information regarding the at least one task and/or the task requestor. For example, FIG. 1 shows absent task and/or task requestor information subtask execution module 54 carrying out (e.g., pointing the lens of the camera at the #2 cellist and taking a picture) the one or more subtasks (e.g., “determine the view of the London Philharmonic from the seat location at the Seattle Theater”) in an absence of information regarding the at least one task (e.g., the devices taking the picture do not know the task of “determining which seats have an unobstructed view of the #2 cellist,” nor does the user of the interface devices taking the picture) and/or the task requestor (e.g., the devices taking the picture do not know the identity of the person making the request, nor does the user of the interface devices know the identity of the person. Additionally, neither the interface devices nor the users of the interface devices know the entity which requested the task). The interface devices only know the location of where the subtask came from, but they do not have information regarding the task that the subtasks will assist in completing, or which entity requested the task. The task may have been requested by the same entity that sent the subtask, but even in this case, the interface devices and the users of the interface devices are not aware of the task or the source of the task requestor.

Referring again to FIG. 4, operational flow 400 depicts operation 406, which depicts transmitting result data comprising a result of carrying out the one or more subtasks. For example, FIG. 1 shows subtask result data transmitting module 46 transmitting result data (e.g., the picture taken of the #2 cellist) comprising a result (e.g., the picture) of carrying out the one or more subtasks (e.g., “determine the view of the London Philharmonic from the seat location at the Seattle Theater”).

FIGS. 5A-5D depict various implementations of operation 402, according to embodiments. For example, referring to FIG. 5A, operation 402 may include operation 502 depicting receiving instructions for obtaining data corresponding to the one or more subtasks, that correspond to at least a portion of at least one task configured to be carried out by two or more discrete interface devices. For example, FIG. 2A shows instruction for obtaining subtask data receiving module 202 receiving instructions for obtaining data (e.g., “activate the barometer to obtain pressure and humidity data at the present location”) corresponding to the one or more subtasks (e.g., “determine the humidity at the present location”), that correspond to at least one task (e.g., “Determine the weather in Seattle at a particular time”) configured to be carried out by two or more discrete interface devices (e.g., a stationary weather station at 2^{nd} Avenue and Thomas St, Seattle, and a smartphone with a barometric pressure sensor carried by a person walking down Denny Way in Seattle, Wash.).

Referring again to FIG. 5A, operation 402 may include operation 504 depicting receiving instructions for retrieving data corresponding to the one or more subtasks that correspond to at least a portion of at least one task configured to be carried out by two or more discrete interface devices. For example, FIG. 2A shows instruction for retrieving subtask data receiving module 204 receiving instructions for retrieving data (e.g., “retrieve the names of wireless networks detected in the previous five minutes and stored in memory”) corresponding to the one or more subtasks (e.g., “determine the density of wireless networks at the locations visited by the interface device”), that correspond to at least a portion of at least one task (e.g., “determine a wireless network density map of the Belltown neighborhood in Seattle”) configured to be carried out by two or more discrete interface devices (e.g., an iPad stored in a backpack with its wireless radio activated and sitting in a chair at a coffee shop, and a motor vehicle with a wireless radio driving down the city streets of Seattle, Wash.).

Referring again to FIG. 5A, operation 504 may further include operation 506 depicting receiving instructions for retrieving data corresponding to the one or more subtasks from a memory, said one or more subtasks corresponding to at least a portion of at least one task configured to be carried out by two or more discrete interface devices. For example, FIG. 2A shows instruction for retrieving subtask data from a memory receiving module 206 receiving instructions for retrieving subtask data corresponding to the one or more subtasks (e.g., “retrieve the temperature fluctuations over the last eight hours”) from a memory (e.g., the previous temperatures were stored on removable memory card on the interface devices), said one or more subtasks corresponding to at least a portion of at least one task (e.g., “determine the hottest part of Alki Beach yesterday”) configured to be carried out by two or more discrete interface devices (e.g., a smartphone with a temperature gauge that stores readings on an external SD card, and a Nike Running-Assistance watch that has a removable USB memory and records the temperature as a person runs down the beach).

Referring again to FIG. 5A, operation 506 may include operation 508 depicting receiving instructions for retrieving data corresponding to the one or more subtasks from a memory stored on a discrete interface device, said one or more subtasks corresponding to at least a portion of at least one task configured to be carried out by two or more discrete interface devices. For example, FIG. 2A shows instruction for retrieving subtask data from a discrete interface device memory receiving module 208 receiving instructions for 206 receiving instructions for retrieving subtask data (e.g., “retrieve the temperature fluctuations over the last eight hours”) corresponding to the one or more subtasks from a memory stored on a discrete interface device (e.g., a Ford Focus with a thermometer), said one or more subtasks corresponding to at least a portion of at least one task (e.g., “determine the cold parts of I-5 where ice may form”) configured to be carried out by two or more discrete interface devices (e.g., a Ford Focus driving down the beach road equipped with a thermometer, and a GPS in-car navigation system that also monitors the weather).

Referring again to FIG. 5A, operation 506 may include operation 510 depicting receiving instructions for retrieving data corresponding to the one or more subtasks from a memory stored on a card that is removable from a discrete interface device, said one or more subtasks corresponding to at least a portion of at least one task configured to be carried out by two or more discrete interface devices. For example, FIG. 2A shows instruction for retrieving subtask from a removable card memory receiving module 210 receiving instructions for retrieving data corresponding to the one or more subtasks (e.g., “retrieve recorded voice data at your location”) from a memory stored on a card (e.g., the voice data is stored on a removable SD card”) that is removable from a discrete interface device (e.g., a Sony voice recorder with an SD card slot), said one or more subtasks corresponding to at least a portion of at least one task (e.g., “determine what President Obama said during his Seattle speech to the Boy Scouts”) configured to be carried out by two or more discrete interface devices (e.g., a microphone-equipped iPhone, and a Sony voice recorder).

Referring again to FIG. 5A, operation 402 may include operation 512 depicting receiving instructions for collecting data corresponding to the one or more subtasks, that correspond to at least a portion of at least one task configured to be carried out by two or more discrete interface devices. For example, FIG. 2A shows instruction for collecting subtask data receiving module 212 receiving instructions for collecting data (e.g., “activate air quality sensor”) corresponding to the one or more subtasks (e.g., “determine the air quality at your location”), that correspond to at least a portion of at least one task configured to be carried out by two or more discrete interface devices (e.g., a pollen counting device mounted in a person's home, and a mobile air quality detector carried by a user).

Referring now to FIG. 5B, operation 402 may include operation 514 depicting receiving instructions for monitoring conditions corresponding to the one or more subtasks, that correspond to at least a portion of at least one task configured to be carried out by two or more discrete interface devices. For example, FIG. 2A shows instruction for monitoring subtask data receiving module 214 receiving instructions for monitoring conditions (e.g., “intermittently turn on the wireless radio and determine how many wireless networks are present”) corresponding to the one or more subtasks (e.g., “determine how many wireless networks are present in your current area”) that correspond to at least a portion of at least one task (e.g., determine which areas of Seattle have insufficient wireless coverage, for targeted ads for air cards) configured to be carried out by two or more discrete interface devices (e.g., a Microsoft Zune with wireless, and a Motorola Droid).

Referring again to FIG. 5B, operation 402 may include operation 516 depicting receiving instructions for activating a sensor of an interface device corresponding to the one or more subtasks, said one or more subtasks corresponding to at least a portion of at least one task configured to be carried out by two or more discrete interface devices. For example, FIG. 2A shows instruction for activating sensor of interface device subtask data receiving module 216 receiving instructions for activating a sensor (e.g., “activate cellular radio”) of an interface device (e.g., a BlackBerry 8800) corresponding to the one or more subtasks (e.g., “activate the cellular radio at your location”), said one or more subtasks corresponding to at least a portion of at least one task (e.g., “determine which parts of Key Arena have the best cell phone signal strength”) configured to be carried out by two or more discrete interface devices (e.g., a BlackBerry 8800 and a Verizon Razr).

Referring again to FIG. 5B, operation 402 may include operation 518 depicting receiving instructions for carrying out an operation corresponding to the one or more subtasks, at a time when another operation is being carried out, said one or more subtasks corresponding to at least a portion of at least one task configured to be carried out by two or more discrete interface devices. For example, FIG. 2A shows instruction for carrying out operation during another operation subtask data receiving module 218 receiving instructions for carrying out an operation (e.g., “activate image capturing component (e.g., the camera)”) corresponding to the one or more subtasks (e.g., “determine the brightness of the sky at the Space Needle by activating the image capturing component”) at a time when another operation is being carried out (e.g., a user pulls his iPhone out of his pocket to check his text messages, at which time the image capturing component is activated and the brightness is detected), said one or more subtasks corresponding to at least a portion of at least one task (e.g., “determine the best time for photographing Puget Sound from the Space Needle”) configured to be carried out by two or more discrete interface devices (e.g., an iPhone and a BlackBerry Bold”).

Referring again to FIG. 5B, operation 418 may further include operation 520 depicting receiving instructions for carrying out a particular operation corresponding to the one or more subtasks, at a time when another operation is being carried out, and without knowledge of the particular operation by a user carrying out another operation, said one or more subtasks corresponding to at least a portion of at least one task configured to be carried out by two or more discrete interface devices. For example, FIG. 2A shows instruction for carrying out operation during another operation without user knowledge subtask data receiving module 220 receiving instructions for carrying out a particular operation (e.g., “measure the amount of pollen detectable by the air quality sensor”) corresponding to the one or more subtasks (e.g., “determine the air quality in your area”), at a time when another operation is being carried out (e.g., a user takes his interface device out of his backpack, where the air is shielded, to send a text message), and without knowledge of the particular operation (e.g., “determine the pollen count”) by a user carrying out another operation (e.g., the user sending a text message does not know his air quality sensor is active and collecting data), said one or more subtasks corresponding to at least a portion of at least one task (e.g., “determine the air quality in Old Town Alexandria”) configured to be carried out by two or more discrete interface devices (e.g., two smartphones with air quality sensors).

Referring now to FIG. 5C, operation 402 may include operation 522 depicting receiving instructions for carrying out an operation corresponding to the one or more subtasks, wherein the operation has preauthorization for being carried out on the discrete interface device of the two or more interface devices, said one or more subtasks corresponding to at least a portion of at least one task configured to be carried out by two or more discrete interface devices. For example, FIG. 2A shows instruction for carrying out operation with preauthorization subtask data receiving module 222 receiving instructions for carrying out an operation (e.g., “activate the wireless radio and determine the number of available unencrypted wireless networks”) corresponding to the one or more subtasks (“determine the available unencrypted wireless networks in your area”), wherein the operation has preauthorization for being carried out (e.g., the user has previously activated an app or clicked a button indicating agreement to allow the subtasks to be carried out on the BlackBerry Torch) on the discrete interface device of the two or more discrete interface devices, said one or more subtasks corresponding to at least a portion of at least one task configured to be carried out by two or more discrete interface devices (e.g., a BlackBerry Torch and an HTC Evo).

Referring again to FIG. 5C, operation 522 may further include operation 536 depicting receiving instructions for carrying out an operation corresponding to the one or more subtasks, wherein the operation has preauthorization for being carried out on the discrete interface device of the two or more interface devices, and said preauthorization is provided by a user of the interface device prior to receipt of the one or more subtasks. For example, FIG. 2A shows instruction for carrying out operation with interface device user preauthorization subtask data receiving module 180 receiving instructions for carrying out an operation (e.g., “activate the GPS sensor”) corresponding to the one or more subtasks (e.g., “determine the location of the device”) wherein the operation has preauthorization for being carried out on the discrete interface device (e.g., the user is not required to confirm or allow anything on the interface device, but the GPS merely activates and runs in the background, where the user may or may not be notified) of the two or more discrete interface devices (e.g., an iPhone 4 and a Pantech Evolution phone), and said preauthorization is provided by a user of the interface device (e.g., in a menu screen on the iPhone, the user selects to allow GPS sensor subtasks to run without explicit authorization for each task) prior to receipt of the one or more subtasks (e.g., this menu selection happens before a subtask is selected).

Referring again to FIG. 5C, operation 536 may further include operation 538 depicting receiving instructions for carrying out an operation corresponding to the one or more subtasks, wherein the operation has preauthorization for being carried out on the discrete interface device of the two or more interface devices, and said preauthorization is provided by a user of the interface device prior to taking possession of the discrete interface device. For example, FIG. 2A shows instruction for carrying out operation with prior possession preauthorization subtask data receiving module 182 receiving instructions for carrying out an operation (e.g., activate an air quality sensor) corresponding to the one or more subtasks (e.g., “measure the air quality at your location”), wherein the operation has preauthorization for being carried out on the discrete interface device (e.g., the smartphone with air quality sensor has been authorized to use the air quality sensor without requesting user authorization) of the two or more interface devices, and said preauthorization is provided by a user of the interface device prior to taking possession of the discrete interface device (e.g., the user agrees to allow certain subtasks, e.g., subtasks that use the air quality sensor, as a condition for taking possession of the smartphone. The user may receive some discount on the cost of the device, or may receive the device for free, in exchange for such preauthorization).

Referring again to FIG. 5C, operation 536 may include operation 540 depicting receiving instructions for carrying out an operation corresponding to the one or more subtasks, wherein the operation has preauthorization for being carried out on the discrete interface device of the two or more interface devices, and said preauthorization is provided by a user of the interface device prior to connection of the interface device to a communication network. For example, FIG. 2A shows instruction for carrying out operation with prior communication network connection preauthorization subtask data receiving module 184 receiving instructions for carrying out an operation (e.g., activate the GPS sensor) corresponding to the one or more subtasks (e.g., “determine the distance traveled by the device in one hour”), wherein the operation has preauthorization for being carried out on the discrete interface device (e.g., the GPS sensor is activated without requesting permission from the user at activation time) of the two or more interface devices, and said preauthorization is provided by a user of the interface device prior to connection of the interface device to a communication network (e.g., the user agrees to allow the GPS sensor to be used as a condition of accessing the communication network, which may be a cellular network, or a local wired/wireless network. The user may receive free or reduced cost access to the communication network in exchange for preauthorizing his or her interface device to allow the GPS sensor to be activated.)

Referring again to FIG. 5C, operation 522 may further include operation 542 depicting receiving instructions for carrying out an operation corresponding to the one or more subtasks, wherein the operation has preauthorization for being carried out on the discrete interface device of the two or more interface devices, and said preauthorization is provided by the discrete interface device. For example, FIG. 2A shows instruction for carrying out operation with device provided preauthorization subtask data receiving module 186 receiving instructions for carrying out an operation (e.g., “activate the speedometer”) corresponding to the one or more subtasks (e.g., “activate the speedometer and determine average speed”) wherein the operation has preauthorization for being carried out on the discrete interface device (e.g., the GPS navigation unit) of the two or more interface devices, and said preauthorization is provided by the discrete interface device (e.g., the preauthorization is part of the device, for example, it's hard wired, or programmed into the device, and as a condition of buying the device, the device tracks the average speed it travels).

Referring again to FIG. 5C, operation 522 may further include operation 544 depicting receiving instructions for carrying out an operation corresponding to the one or more subtasks, wherein the operation has preauthorization for being carried out on the discrete interface device of the two or more interface devices, and said preauthorization is provided by a provider of a communication network in communication with the discrete interface device. For example, FIG. 2A shows instruction for carrying out operation with communication network provider preauthorization subtask data receiving module 188 receiving instructions for carrying out an operation (e.g., “activate the image capturing component”) corresponding to the one or more subtasks (e.g., “take a picture of Times Square”), wherein the operation has preauthorization for being carried out on the discrete interface device (e.g., the Blackberry Torch) of the two or more interface devices, and said preauthorization is provided by a provider of a communication network (e.g., AT&T) in communication with the discrete interface device (e.g., AT&T, through previously obtained rights from the user, authorizes the activation of a component of an interface device, without requiring user authorization).

Referring now to FIG. 5D, operation 402 may include operation 524 depicting receiving instructions for presenting one or more directions to be carried out by a user of a discrete interface device to complete at least a portion of the one or more subtasks, said one or more subtasks corresponding to at least a portion of at least one task configured to be carried out by two or more discrete interface devices. For example, FIG. 2A shows instruction for presenting user directions for completing subtask data receiving module 224 receiving instructions for presenting one or more directions (e.g., “point the interface device in the direction indicated on the display” and “activate the camera”) to be carried out by a user of a discrete interface device (e.g., a user of an iPhone) to complete at least a portion of the one or more subtasks (e.g., “take a picture of the Space Needle”), said one or more subtasks corresponding to at least a portion of at least one task configured to be carried out by two or more discrete interface devices (e.g., an iPhone and a Samsung Galaxy SII).

Referring now to FIG. 5D, operation 402 may include operation 526 depicting receiving subtask data including one or more subtasks that correspond to at least one portion of at least one task requested by a discrete interface device and configured to be carried out by two or more other discrete interface devices. For example, FIG. 2A shows portion of task requested by discrete interface device receiving module 226 receiving subtask data (e.g., the subtask, and instructions for carrying out the subtask) including one or more subtasks (e.g., “determine the view of the bullpen from your section of Safeco field”) that correspond to at least one portion of at least one task (e.g., “determine which sections of Safeco Field can see the visitor bullpen”) requested by a discrete interface device (e.g., an interface device belonging to a user sitting in a seat at Safeco Field that has no bullpen view) and configured to be carried out by two or more discrete interface devices (e.g., an iPhone of a user in section 327, and a BlackBerry of a user in Section 205).

Referring again to FIG. 5D, operation 402 may include operation 528 depicting receiving subtask data including one or more subtasks that correspond to at least one portion of at least one task requested by a provider of a communication network, said one or more subtasks corresponding to at least one task configured to be carried out by two or more discrete interface devices. For example, FIG. 2A shows portion of task requested by communication network provider subtask receiving module 228 receiving subtask data including one or more subtasks (e.g., “determine the cellular signal strength at your location”) that correspond to at least one portion of at least one task (e.g., determine the actual coverage of our cellular network on a Tuesday night”) requested by a provider of a communication network (e.g., AT&T), said one or more subtasks corresponding to at least a portion of at least one task configured to be carried out by two or more discrete interface devices (e.g., a Nokia E5 and an iPhone 4).

Referring again to FIG. 5D, operation 402 may include operation 530 depicting receiving subtask data including one or more subtasks that correspond to at least one portion of at least one task requested by a subtask creator, said one or more subtasks corresponding to at least one task configured to be carried out by two or more discrete interface devices. For example, FIG. 2A shows portion of task requested by subtask creator subtask receiving module 230 receiving subtask data including one or more subtasks (e.g., “determine how many Bluetooth-enabled devices are listening in your area”) that correspond to at least one portion of at least one task (e.g., “determine Bluetooth penetration at the Seattle Sounders game”) requested by a subtask creator (e.g., a server that creates the subtasks from the received task requests, that wishes to know Bluetooth penetration information in order to better create subtasks to distribute from the received task requests), said one or more subtasks corresponding to at least one portion of at least one task configured to be carried out by two or more discrete interface devices (e.g., a wireless Bluetooth keyboard used by a reporter typing his report at the game, and a wireless headset linked to a smartphone of a user in the front row of the stadium).

Referring again to FIG. 5D, operation 402 may include operation 532 depicting receiving subtask data including one or more subtasks that correspond to at least one portion of at least one task requested by a subtask presentor, said one or more subtasks corresponding to at least one task configured to be carried out by two or more discrete interface devices. For example, FIG. 2A shows portion of task requested by subtask presentor subtask receiving module 232 receiving subtask data including one or more subtasks (e.g., “determine the visibility/cloud cover at the Space Needle”) that correspond to at least one portion of at least one task (e.g., “determine whether pictures of Mt. Rainier can be taken from the Space Needle”) requested by a subtask presentor (e.g., the distributor of subtasks wants to determine picture availability in order to determine whether to distribute subtasks that involve taking pictures of Mt. Rainier to users of interface devices at the Space Needle, to determine how best to distribute subtasks in order to complete received subtasks and task requests), said one or more subtasks corresponding to at least one task (e.g., take a high-quality 360 degree picture of Mt. Rainier”) configured to be carried out by two or more discrete interface devices (e.g., a Canon Rebel XTI camera and a Sony PowerShot digital networked camera).

Referring again to FIG. 5D, operation 402 may include operation 534 depicting receiving subtask data including one or more subtasks that correspond to at least one portion of at least one task requested by a news aggregator, said one or more subtasks corresponding to at least one task configured to be carried out by two or more discrete interface devices. For example, FIG. 2A shows portion of task requested by news aggregator subtask receiving module 234 receiving subtask data including one or more subtasks (e.g., “determine the temperature at your location,” “determine the barometric pressure at your location”) that correspond to at least one portion of at least one task (e.g., “determine the up-to-the-minute weather information”) requested by a news aggregator (e.g., the Weather Channel), said one or more subtasks corresponding to at least a portion of at least one task configured to be carried out by two or more discrete interface devices (e.g., a smartphone equipped with weather detecting sensors, a home weather station installed in a user's house, an OnStar equipped vehicle with a thermometer, and a licensed, locally-owned stationary weather station collecting weather data).

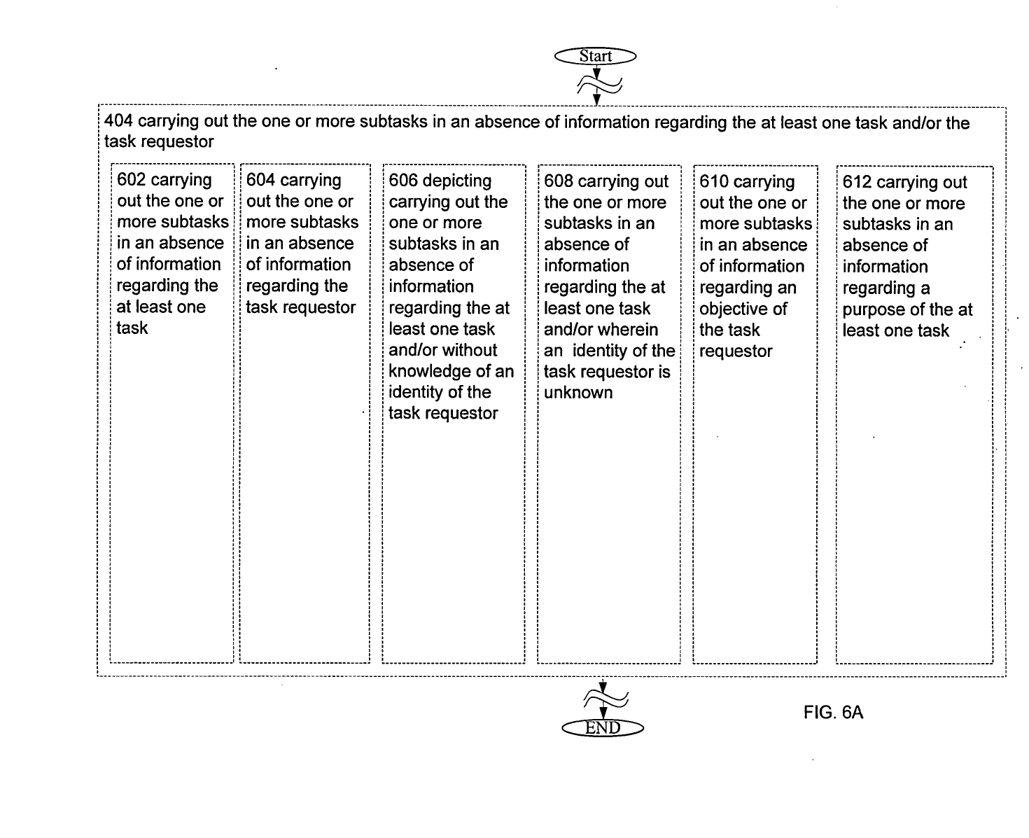

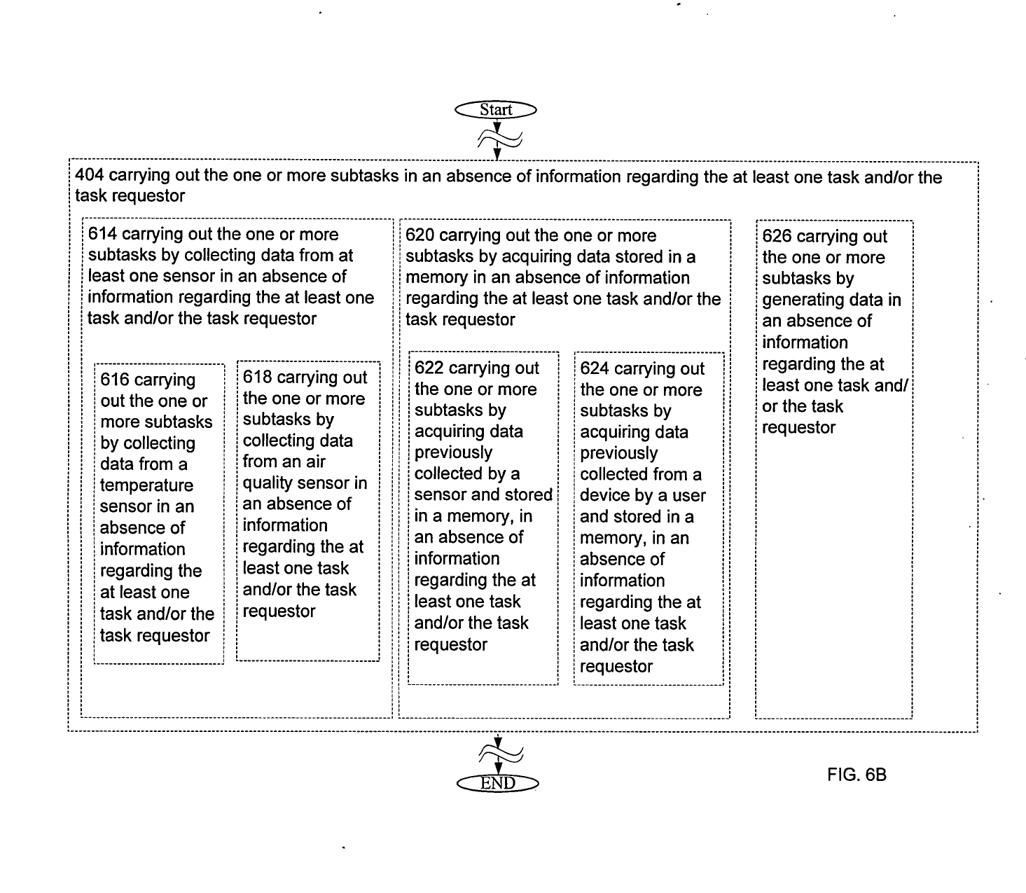

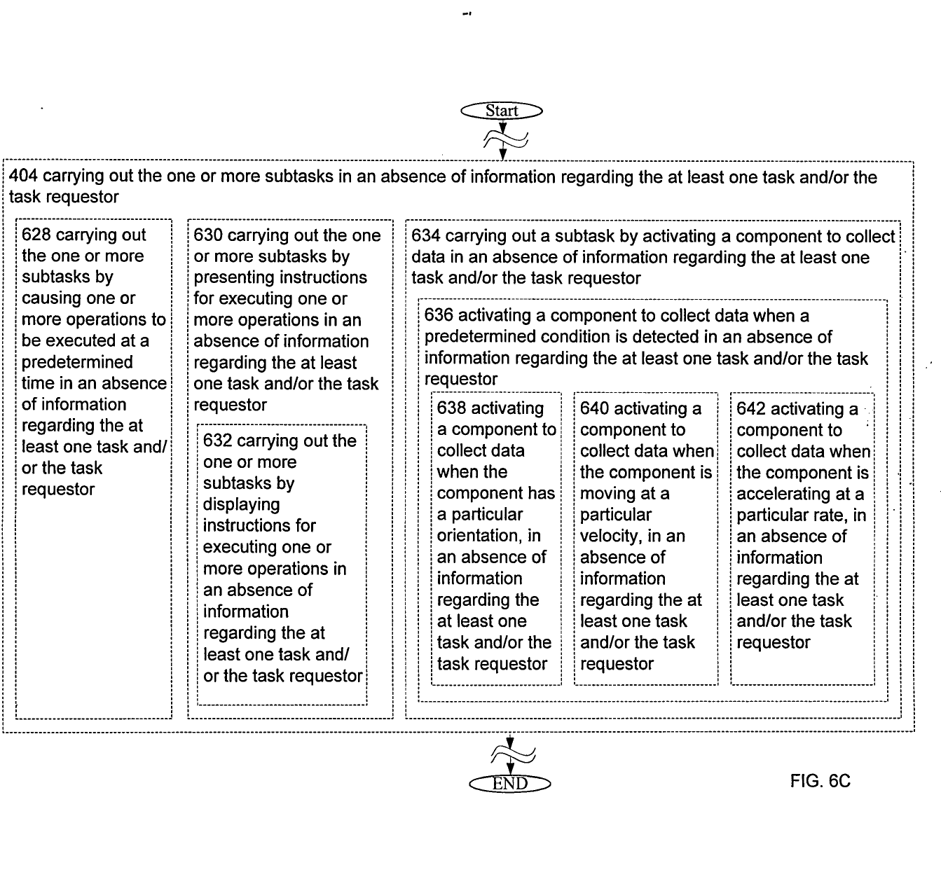

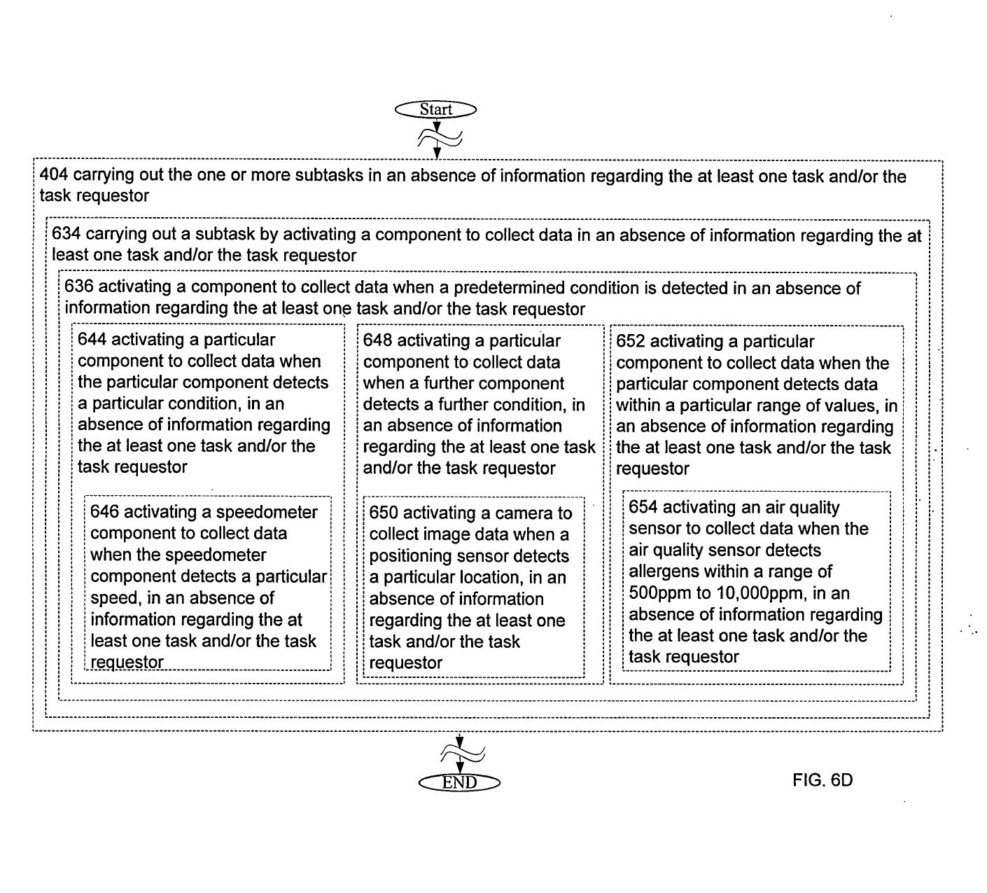

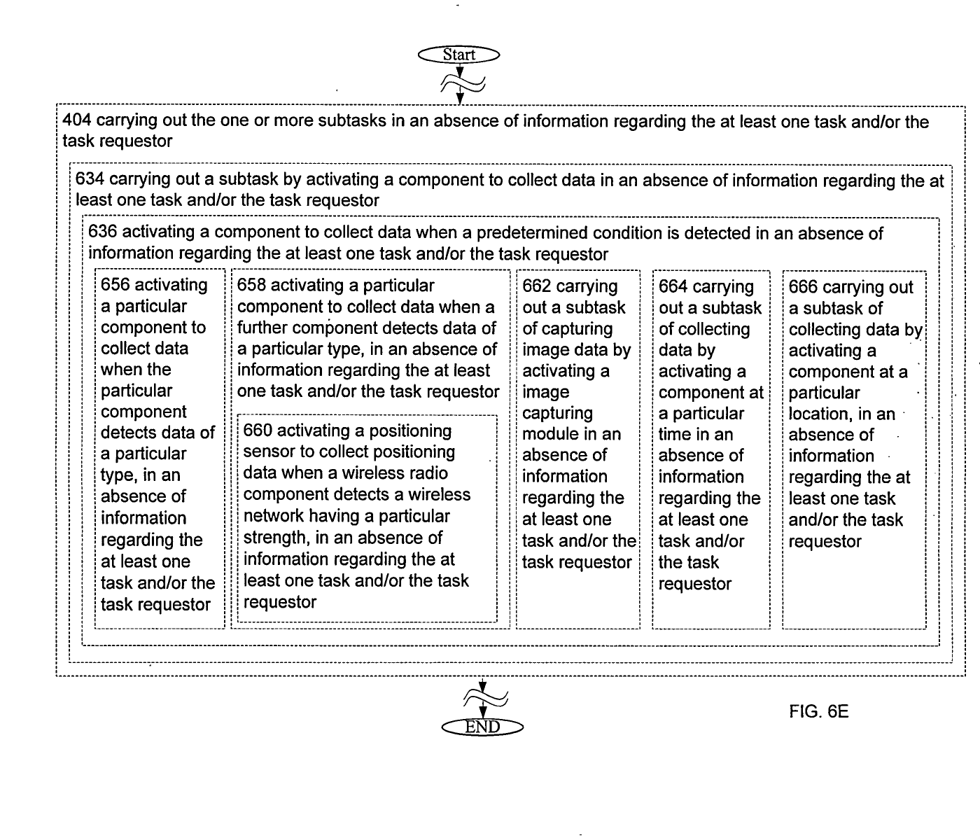

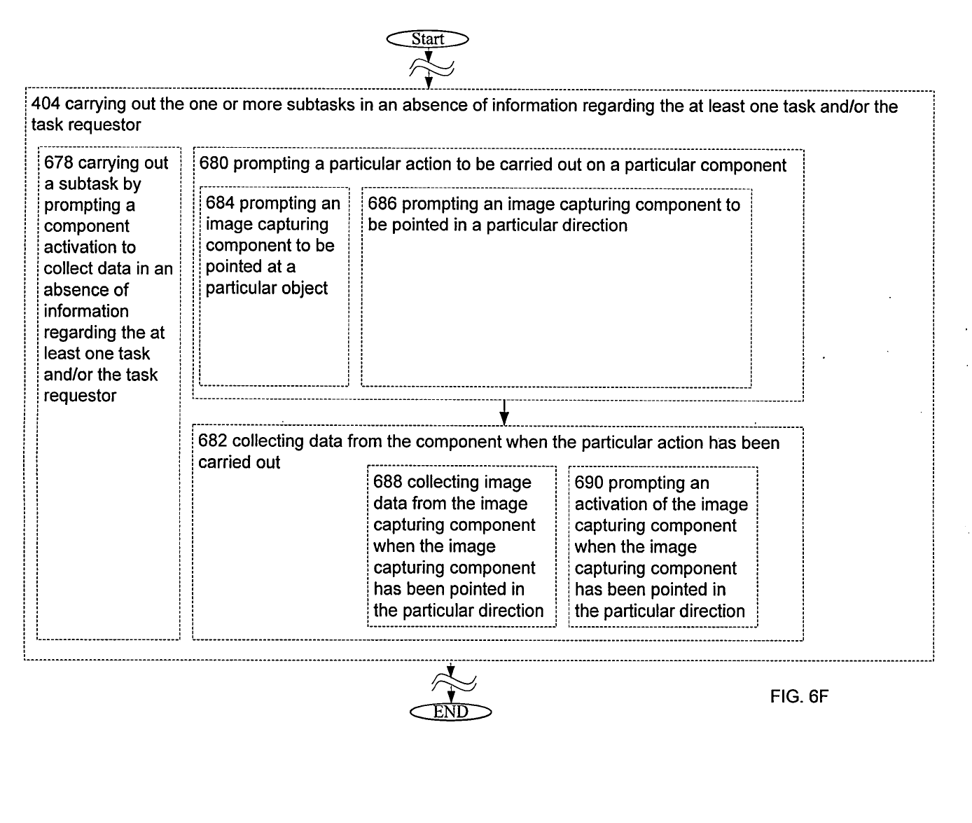

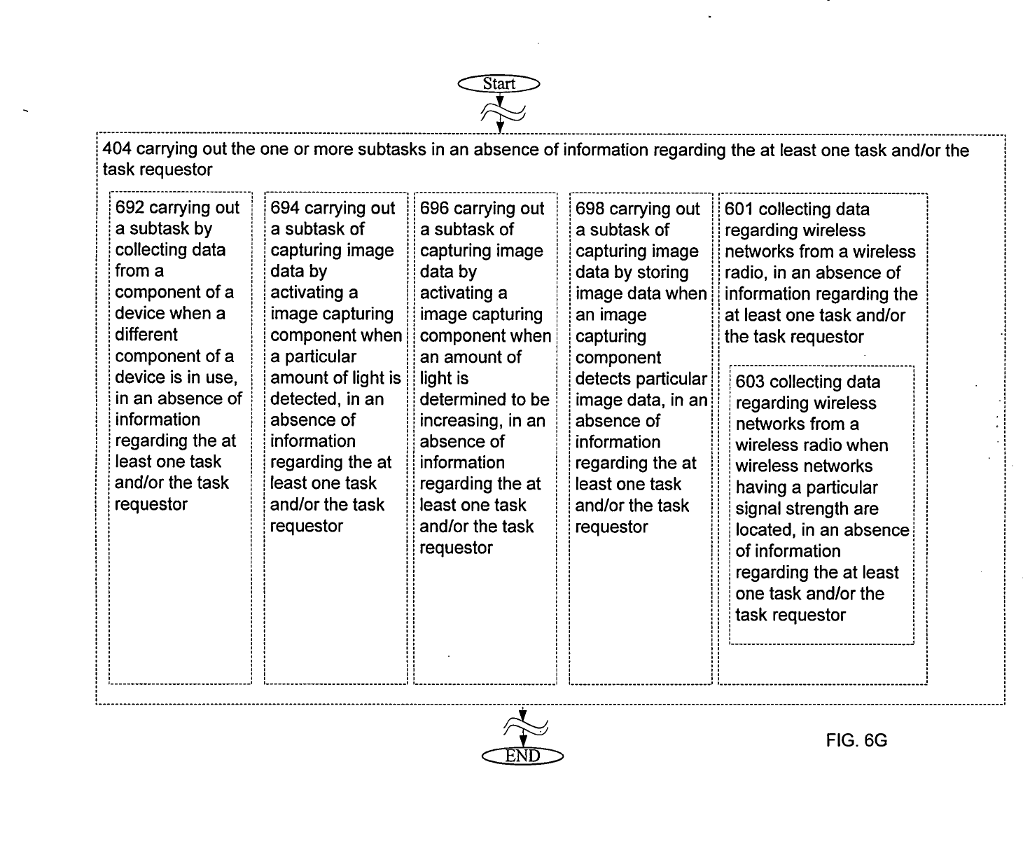

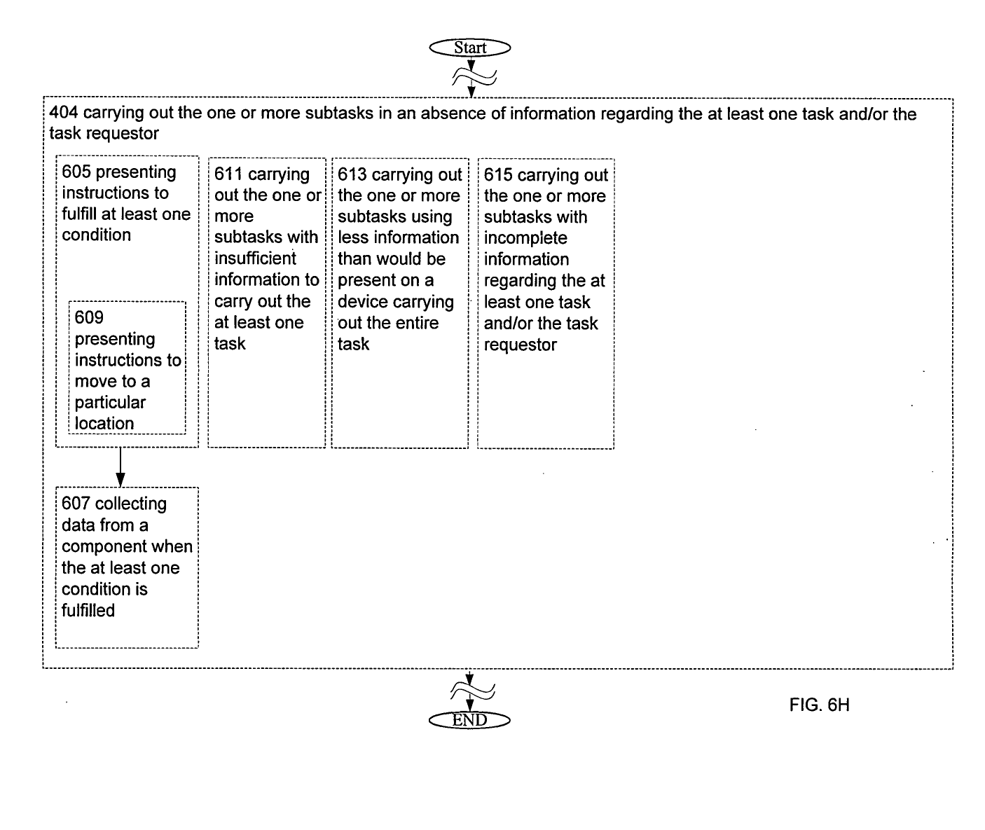

Referring now to FIG. 6A, operation 404 may include operation 602 depicting carrying out the one or more subtasks in an absence of information regarding the at least one task. For example, referring now to FIG. 2B, FIG. 2B shows absent task information subtask carrying out module 236 carrying out the one or more subtasks (e.g., “point the cellular telephone in a particular direction and activate the image capturing component”) in an absence of information (e.g., the interface device and the user of the interface device do not know why the image capturing component is being activated) regarding the at least one task (e.g., “take a 360-degree picture of the Eiffel Tower,” which information is not available to the interface device).

Referring again to FIG. 6A, operation 404 may include operation 604 depicting carrying out the one or more subtasks in an absence of information regarding the task requestor. For example, FIG. 2B shows absent task requestor information subtask carrying out module 238 carrying out the one or more subtasks (e.g., “determine cellular signal strength”) in an absence of information regarding the task requestor (e.g., the interface device and the user of the interface device do not know who is requesting the information, their motive for requesting the information, whether it is a cellular network gathering data, a subtask distributor trying to improve subtask distribution efficiency, or a person trying to determine where to drink coffee based on the strength of signal he might receive).

Referring again to FIG. 6A, operation 404 may include operation 606 depicting carrying out the one or more subtasks in an absence of information regarding the at least one task and/or without knowledge of an identity of the task requestor. For example, FIG. 2B shows absent task requestor identity subtask carrying out module 240 carrying out the one or more subtasks (e.g., “determine the sunlight level at the Space Needle”) in an absence of information regarding the at least one task (e.g., “determine the time of sunset at the Space Needle”) the interface device and the user of the interface device do not know the task which this subtask of “determining the sunlight level at the Space Needle” will complete) and/or without knowledge of an identity of the task requestor (e.g., the interface device and the user of the interface device do not know the identity of the task requestor, e.g., which person or interface device is requesting the determining the time of sunset at the Space Needle, or whether it is a person or interface device at all. In addition, the interface device and the user of the interface device do not know the identity of any server, network, or other device used to transmit the task or separate the task into separate subtasks. In some embodiments, the interface device carrying out the subtask and the user of the interface device carrying out the subtask have no knowledge of any entity beyond the entity that transmitted the subtask to the interface device).

Referring again to FIG. 6A, operation 404 may include operation 608 depicting carrying out the one or more subtasks in an absence of information regarding the at least one task and/or wherein an identity of the task requestor is unknown. For example, FIG. 2B shows unknown task requestor identity subtask carrying out module 242 carrying out the one or more subtasks (e.g., “determine the audio quality of the Pearl Jam Concert at your seat at the Seattle Theater”) in an absence of information regarding the at least one task (e.g., the interface device and the user of the interface device do not know the task for which this subtask is being carried out) and/or wherein an identity of the task requestor is unknown (e.g., the interface device and the user of the interface device, and in some embodiments, the subtask distributor, do not know the identity of the entity requesting the task, or any details regarding the entity, whether it is a person, or Ticketmaster, or the record label that licenses Pearl Jam).

Referring again to FIG. 6A, operation 404 may include operation 610 depicting carrying out the one or more subtasks in an absence of information regarding an objective of the task requestor. For example, FIG. 2B shows unknown task requestor objective subtask carrying out module 244 carrying out the one or more subtasks (e.g., “determine the view of the whales from your seat at Sea World”) in an absence of information regarding an objective (e.g., determining which seats should cost more money) of the task requestor (e.g., an owner of Sea World)

Referring again to FIG. 6A, operation 404 may include operation 612 depicting carrying out the one or more subtasks in an absence of information regarding a purpose of the at least one task. For example, FIG. 2B shows unknown task purpose subtask carrying out module 246 carrying out the one or more subtasks (e.g., “determine the wait for the Iron Man 3 movie at the theater at your location”) in an absence of information regarding a purpose of the at least one task (e.g., the task may be “determine how popular the Iron Man 3 movie is,” and the purpose may be a studio trying to project ticket sales, or a couple on a date trying to find a movie to see that will have a nearly-empty theater).

Referring now to FIG. 6B, operation 404 may include operation 614 depicting carrying out the one or more subtasks by collecting data from at least one sensor in an absence of information regarding the at least one task and/or the task requestor. For example, FIG. 2B shows sensor data collection subtask carrying out module 248 carrying out the one or more subtasks (e.g., “take a picture of the Eiffel Tower”) by collecting data (e.g., image data) from at least one sensor (e.g., the image capturing component”) in an absence of information regarding the at least one task and/or the task requestor.

Referring again to FIG. 6B, operation 614 may include operation 616 depicting carrying out the one or more subtasks by collecting data from a temperature sensor in an absence of information regarding the at least one task and/or the task requestor. For example, FIG. 2B shows temperature sensor data collection subtask carrying out module 250 carrying out the one or more subtasks (e.g., “determine the temperature at your current location”) by collecting data from a temperature sensor (e.g., a thermometer on an Android device) in an absence of information regarding the at least one task (e.g., the Android device does not know the task is “determine where it is likely to snow tonight”) and/or the task requestor (e.g., the person making the request is not known to the interface device).

Referring again to FIG. 6B, operation 614 may include operation 618 depicting carrying out the one or more subtasks by collecting data from an air quality sensor in an absence of information regarding the at least one task and/or the task requestor. For example, FIG. 2B shows air quality sensor data collection subtask carrying out module 252 carrying out the one or more subtasks (e.g., “determine the pollen count at your location”) by collecting data from an air quality sensor (e.g., a home weather station) in an absence of information regarding the at least one task (e.g., “determine which West Coast city a user can visit without triggering that user's allergies”) and/or the task requestor (e.g., the person or entity making the request is not known to a user of the interface device or the interface device.

Referring again to FIG. 6B, operation 404 may include operation 620 depicting carrying out the one or more subtasks by acquiring data stored in a memory in an absence of information regarding the at least one task and/or the task requestor. For example, FIG. 2B shows memory data acquisition subtask carrying out module 254 carrying out the one or more subtasks (e.g., “determine how much traffic is on the 520 Bridge”) by acquiring data stored in a memory (e.g., speed data from a GPS device mounted on a car that stores information in its memory banks) in an absence of information regarding the at least one task and/or the task requestor (e.g., the GPS device and a user of the GPS device do not know which entity is requesting speed information or what task the speed information will be used to complete).

Referring again to FIG. 6B, operation 620 may include operation 622 depicting carrying out the one or more subtasks by acquiring data previously collected by a sensor and stored in a memory, in an absence of information regarding the at least one task and/or the task requestor. For example, FIG. 2B shows sensor collected stored memory data acquisition subtask carrying out module 256 carrying out the one or more subtasks (e.g., “determine how much precipitation has fallen in the last 24 hours) by acquiring data previously collected by a sensor (e.g., a rain sensor mounted on a portable weather station) and stored in a memory (e.g., the hard drive of the portable weather station), in an absence of information regarding the at least one task and/or the task requestor.

Referring again to FIG. 6B, operation 620 may include operation 624 depicting carrying out the one or more subtasks by acquiring data previously collected from a sensor by a user and stored in a memory, in an absence of information regarding the at least one task and/or the task requestor. For example, FIG. 2B shows user-collected sensor stored memory data acquisition subtask carrying out module 258 carrying out the one or more subtasks (e.g., “find a picture of the Space Needle”) by acquiring data previously collected from a device (e.g., pictures of the Space Needle previously taken”) by a user (e.g., the user of the iPhone that took the pictures) and stored in a memory (e.g., the pictures were stored to an inserted SD card), in an absence of information regarding the at least one task and/or the task requestor

Referring again to FIG. 6B, operation 404 may include operation 626 depicting carrying out the one or more subtasks by generating data in an absence of information regarding the at least one task and/or the task requestor. For example, FIG. 2B shows data generation subtask carrying out module 260 carrying out the one or more subtasks (e.g., “determine the smog level in downtown Bellevue”) by generating data (e.g., smog data from an air quality sensor of a smartphone with an air quality sensor) in an absence of information regarding the at least one task and/or the task requestor.

Referring now to FIG. 6C, operation 404 may include operation 628 depicting carrying out the one or more subtasks by causing one or more operations to be executed at a predetermined time in an absence of information regarding the at least one task and/or the task requestor. For example, FIG. 2B shows operations executed at predetermined time subtask carrying out module 262 carrying out the one or more subtasks (e.g., “determine the loudness of the Led Zeppelin cover band concert”) by causing one or more operations to be executed at a predetermined time (e.g., 7:30 pm, the point at which the band is supposed to play) in an absence of information regarding the at least one task and/or the task requestor.

Referring again to FIG. 6C, operation 404 may include operation 630 depicting carrying out the one or more subtasks by presenting instructions for executing one or more operations in an absence of information regarding the at least one task and/or the task requestor. For example, FIG. 2B shows presenting instruction for executing operations subtask carrying out module 264 carrying out the one or more subtasks (e.g., “take a picture of the Space Needle”) by presenting instructions (e.g., “the phone will emit a series of beeps of changing volume, walk in the direction by which the beeps get louder and closer together, then take a picture”) for executing one or more operations (e.g., take a picture of the Space Needle”) in an absence of information regarding the at least one task and/or the task requestor.

Referring again to FIG. 6C, operation 630 may include operation 632 depicting carrying out the one or more subtasks by displaying instructions for executing one or more operations in an absence of information regarding the at least one task and/or the task requestor. For example, FIG. 2B shows displaying instruction for executing operations subtask carrying out module 266 carrying out the one or more subtasks (e.g., measure the wireless signal strength) by displaying instructions (e.g., displaying the words “activate the wireless radio on your Galaxy Tab” on the screen of the Samsung Galaxy Tab) for executing one or more operations (e.g., measuring wireless signal strength”) in an absence of information regarding the at least one task and/or the task requestor.

Referring again to FIG. 6C, operation 404 may include operation 634 depicting carrying out a subtask by activating a component to collect data in an absence of information regarding the at least one task and/or the task requestor. For example, FIG. 2B shows data collection by component activation subtask carrying out module 268 carrying out a subtask (e.g., “determine a time of sunset by measuring the rate of brightness decrease”) by activating a component (e.g., an image capturing component of a Pantech Revolution smartphone) to collect data (e.g., brightness data) in an absence of information regarding the at least one task and/or the task requestor.

Referring again to FIG. 6C, operation 634 may include operation 636 depicting activating a component to collect data when a predetermined condition is detected in an absence of information regarding the at least one task and/or the task requestor. For example, FIG. 2B shows predetermined condition data collection by component activation subtask carrying out module 270 activating a component (e.g., activating an air quality sensor) when a predetermined condition (e.g., the interface device is at the corner of 2^{nd} Ave. and Mercer Street) in an absence of information regarding the at least one task and/or the task requestor.

Referring again to FIG. 6C, operation 636 may include operation 638 depicting activating a component to collect data when the component has a particular orientation, in an absence of information regarding the at least one task and/or the task requestor. For example, FIG. 2B shows particular orientation data collection by component activation subtask carrying out module 272 activating a component (e.g., an image capturing component) to collect data (e.g., image data) when the component has a particular orientation (e.g., when the component is pointed 277 degrees at a particular location to take a picture of Mt. Rainier), in an absence of information regarding the at least one task and/or the task requestor.

Referring again to FIG. 6C, operation 636 may include operation 640 depicting activating a component to collect data when the component is moving at a particular velocity, in an absence of information regarding the at least one task and/or the task requestor. For example, FIG. 2B shows particular velocity data collection by component activation subtask carrying out module 274 activating a component (e.g., a GPS positioning sensor) to collect data (e.g., position data regarding which road a device is traveling on and where on that road the device is located) when the component is moving at a particular velocity (e.g., greater than the speed limit, e.g., greater than 65 miles per hour), in an absence of information regarding the at least one task and/or the task requestor (e.g., the interface device has no idea it may be the police collecting this data, or a vehicle manufacturer, or an insurance company).

Referring again to FIG. 6C, operation 636 may include operation 642 depicting activating a component to collect data when the component is accelerating at a particular rate, in an absence of information regarding the at least one task and/or the task requestor. For example, FIG. 2B shows particular acceleration rate data collection by component activation subtask carrying out module 276 activating a component (e.g., a G-force sensor) to collect data (e.g., gravitational force data) when the component is accelerating at a particular rate (e.g., 0.8 Gs), in an absence of information regarding the at least one task and/or the task requestor (e.g., the task requestor may be an autocross driver trying to determine which curves on the track are causing too much acceleration in his car).

Referring now to FIG. 6D, operation 636 may include operation 644 depicting activating a particular component to collect data when the particular component detects a particular condition, in an absence of information regarding the at least one task and/or the task requestor. For example, FIG. 2B shows particular component detecting particular condition subtask carrying out module 278 activating a particular component (e.g., a barometer) when the particular component detects a particular condition (e.g., barometric pressure under 55), in an absence of information regarding the at least one task and/or the task requestor.

Referring again to FIG. 6D, operation 644 may include operation 646 depicting activating a speedometer component to collect data when the speedometer component detects a particular speed, in an absence of information regarding the at least one task and/or the task requestor. For example, FIG. 2B shows speedometer component detecting particular speed subtask carrying out module 280 activating a speedometer component to collect data (e.g., velocity data) when the speedometer component detects a particular speed (e.g., greater than zero, the data may be ignored as long as the data is zero, e.g., the interface device is not moving), in an absence of information regarding the at least one task and/or the task requestor.

Referring again to FIG. 6D, operation 636 may include operation 648 depicting activating a particular component to collect data when a further component detects a further condition, in an absence of information regarding the at least one task and/or the task requestor. For example, FIG. 2B shows further component detecting further condition triggering particular component subtask carrying out module 282 activating a particular component to collect data (e.g., a wireless radio) to collect data when a further component (e.g., a GPS positioning sensor) detects a further condition (e.g., the interface device is located at a Starbucks Coffee”), in an absence of information regarding the at least one task and/or the task requestor.

Referring again to FIG. 6D, operation 648 may include operation 650 depicting activating an image capturing component to collect image data when a positioning sensor detects a particular location, in an absence of information regarding the at least one task and/or the task requestor. For example, FIG. 2B shows positioning sensor detecting particular location triggering image capturing component activation subtask carrying out module 284 activating an image capturing component (e.g., a camera on an iPhone) to collect image data when a positioning sensor detects a particular location (e.g., Times Square), in an absence of information regarding the at least one task and/or the task requestor.

Referring again to FIG. 6D, operation 636 may include operation 652 depicting activating a particular component to collect data when the particular component detects data within a particular range of values, in an absence of information regarding the at least one task and/or the task requestor. For example, FIG. 2B shows particular range of values triggering particular component subtask carrying out module 286 activating a particular component (e.g., a temperature sensor) when the particular component detects data within a particular range of values (e.g., between 200 degrees Fahrenheit and 300 degrees Fahrenheit), in an absence of information regarding the at least one task (e.g., the interface device does not know that it is collecting temperature data to determine where a particular mechanical device may be overheating) and/or the task requestor.

Referring again to FIG. 6D, operation 652 may include operation 654 depicting activating an air quality sensor to collect data when the air quality sensor detects allergens within a range of 5000 ppm to 10,000 ppm, in an absence of information regarding the at least one task and/or the task requestor. For example, FIG. 2B shows particular air quality triggering air quality sensor subtask carrying out module 288 activating an air quality sensor (e.g., an air quality sensor on an iPhone) to collect data when the air quality sensor detects allergens within a range of 5000 ppm to 10,000 ppm, (e.g., where the allergen level is elevated) in an absence of information regarding the at least one task and/or the task requestor.

Referring now to FIG. 6E, operation 636 may include operation 656 depicting activating a particular component to collect data when the particular component detects data of a particular type, in an absence of information regarding the at least one task and/or the task requestor. For example, FIG. 2B shows detecting particular type data triggering particular component activation subtask carrying out module 290 activating a particular component (e.g., an image capturing component) to collect data when the particular component detects data of a particular type (e.g., image data having a particular color pattern or image histogram indicating it will be a good picture), in an absence of information regarding the at least one task and/or the task requestor.

Referring again to FIG. 6E, operation 636 may include operation 658 depicting activating a particular component to collect data when a further component detects data of a particular type, in an absence of information regarding the at least one task and/or the task requestor. For example, FIG. 2B shows further component detecting particular type data triggering particular component activation subtask carrying out module 292 activating a particular component (e.g., a GPS positioning sensor) to collect data (e.g., position data) when a further component (e.g., an image capturing component) detects data of a particular type (e.g., image data having a particular image histogram indicating a balanced picture), in an absence of information regarding the at least one task and/or the task requestor.

Referring again to FIG. 6E, operation 658 may include operation 660 depicting activating a positioning sensor to collect positioning data when a wireless radio component detects a wireless network having a particular strength, in an absence of information regarding the at least one task and/or the task requestor. For example, FIG. 2B shows wireless radio detecting particular wireless network strength triggering positioning data collection subtask carrying out module 294 activating a positioning sensor (e.g., the GPS sensor on an ASUS Transformer) to collect positioning data (e.g., location, e.g., which store or coffee shop the interface device is located in) when a wireless radio component (e.g., the ASUS Transformer wireless radio) detects a wireless network having a particular strength, in an absence of information regarding the at least one task and/or the task requestor.

Referring again to FIG. 6E, operation 636 may include operation 662 depicting carrying out a subtask of capturing image data by activating an image capturing component in an absence of information regarding the at least one task and/or the task requestor. For example, FIG. 2B shows image capturing subtask carrying out module 296 carrying out a subtask of capturing image data (e.g., a subtask of “take a picture of the Empire State Building”) by activating an image capturing component (e.g., a webcam of an EeePc of a person sitting on a park bench in New York) in an absence of information regarding the at least one task and/or the task requestor.

Referring again to FIG. 6E, operation 636 may include operation 664 depicting carrying out a subtask of collecting data by activating a component at a particular time in an absence of information regarding the at least one task and/or the task requestor. For example, FIG. 2B shows particular time triggering component activation subtask carrying out module 298 carrying out a subtask of collecting data (e.g., “collect speed data on the Light Rail train”) by activating a component (e.g., a speed detecting component) at a particular time (e.g., a time programmed to be rush hour, e.g., 5 pm, for a person commuting on the train) in an absence of information regarding the at least one task and/or the task requestor.

Referring again to FIG. 6E, operation 636 may include operation 666 depicting carrying out a subtask of collecting data by activating a component at a particular location, in an absence of information regarding the at least one task and/or the task requestor. For example, FIG. 2B shows particular location triggering component activation subtask carrying out module 201 carrying out a subtask of collecting data (e.g., “collect temperature data for Alki Beach”) by activating a component (e.g., a thermometer component of a smartphone) at a particular location (e.g., when the smartphone interface device is located at Alki Beach), in an absence of information regarding the at least one task and/or the task requestor.

Referring now to FIG. 6F, operation 404 may include operation 678 depicting carrying out a subtask by prompting a component activation to collect data in an absence of information regarding the at least one task and/or the task requestor. For example, FIG. 2B shows prompting component activation subtask carrying out module 213 carrying out a subtask by prompting (e.g., displaying instructions for a user to activate (e.g., turn on or use)) a component activation (e.g., a wireless radio of a Nook Color) to collect data (e.g., data regarding wireless networks) in an absence of information regarding the at least one task and/or the task requestor.

Referring again to FIG. 6F, operation 404 may include operation 680 depicting prompting a particular action to be carried out on a particular component. For example, FIG. 2B shows particular action for particular component prompting module 215 prompting (e.g., displaying instructions on a screen of an interface device (e.g., a touchscreen of a Microsoft Zune HD) or presenting instructions through headphones or speakers) a particular action (e.g., activate a component, e.g., activate a microphone for recording) to be carried out on a particular component (e.g., a microphone, to record sound levels).

Referring again to FIG. 6F, operation 404, which may include operation 680, also may include operation 682 depicting collecting data from the component when the particular action has been carried out. For example, FIG. 2B shows particular action triggering component data collecting module 217 collecting data (e.g., sound data) from the component (e.g., the microphone of the Samsung Epic 4G) when the particular action (e.g., activating the microphone) has been carried out (e.g., the Samsung Epic detects that the user has activated the microphone in response to the prompting in the previous step).

Referring again to FIG. 6F, operation 680 may include operation 684 depicting prompting an image capturing component to be pointed at a particular object. For example, FIG. 2B shows image capturing component pointed at particular object prompting module 219 prompting (e.g., displaying instructions on a display or playing instructions through a speaker or microphone) an image capturing component (e.g., a camera of a Nokia E5 smartphone) to be pointed at a particular object (e.g., by displaying an arrow on the E5 screen pointing in the direction, or displaying a photo of the particular object to be photographed).

Referring again to FIG. 6F, operation 680 may include operation 686 depicting prompting an image capturing component to be pointed in a particular direction. For example, FIG. 2B shows image capturing component pointed in particular direction prompting module 221 prompting (e.g., displaying instructions on a display or playing instructions through a speaker or microphone) an image capturing component (e.g., a camera of a Motorola Droid) to be pointed in a particular direction (e.g., toward the direction to which image data is to be captured, e.g., by displaying an arrow on the screen, or a series of verbal commands through a microphone).

Referring again to FIG. 6F, operation 682 may include operation 688 depicting collecting image data from the image capturing component when the image capturing component has been pointed in the particular direction. For example, FIG. 2B shows pointed particular direction triggering image capturing component data collecting module 223 collecting image data from the image capturing component (e.g., taking a picture with the camera of an iPhone) when the image capturing component (e.g., the camera of the iPhone) has been pointed in the particular direction (e.g., toward the item to be captured in a picture, e.g., Times Square in New York)

Referring again to FIG. 6F, operation 682 may include operation 690 depicting prompting an activation of the image capturing component when the image capturing component has been pointed in the particular direction. For example, FIG. 2B shows pointed particular direction triggering image capturing component activation prompting module 225 prompting (e.g., displaying instructions on the screen, or presenting instructions through earphones or speakers) an activation of the image capturing component (e.g., activating the shutter of the camera) when the image capturing component (e.g., the camera of a Dell Streak) has been pointed in the particular direction (e.g., toward the item to be captured in a picture, e.g., Mount Rushmore).

Referring now to FIG. 6G, operation 404 may include operation 692 depicting carrying out a subtask by collecting data from a component of a device when a different component of a device is in use, in an absence of information regarding the at least one task and/or the task requestor. For example, FIG. 2B shows component collecting data during different component use subtask carrying out module 227 carrying out a subtask (e.g., “take a picture of the area around Times Square”) by collecting data from a component of a device (e.g., collecting image data from the image capturing component of a Droid Razr smartphone) when a different component of a device is in use (e.g., when a user is operating the Droid Razr to send an email), in an absence of information regarding the at least one task and/or the task requestor.

Referring again to FIG. 6G, operation 404 may include operation 694 depicting carrying out a subtask of capturing image data by activating an image capturing component when a particular amount of light is detected, in an absence of information regarding the at least one task and/or the task requestor. For example, FIG. 2B shows detected particular light triggering image capturing component activation subtask carrying out module 229 carrying out a subtask of capturing image data (e.g., “take a picture of Puget Sound when the sun is shining”) by activating an image capturing component (e.g., activating the shutter of a camera on an HTC Evo smartphone) when a particular amount of light is detected (e.g., when the HTC Evo camera determines that a brightness is over 60%, indicating that the sun is out), in an absence of information regarding the at least one task and/or the task requestor.

Referring again to FIG. 6G, operation 404 may include operation 696 depicting carrying out a subtask of capturing image data by activating a image capturing component when an amount of light is determined to be increasing, in an absence of information regarding the at least one task and/or the task requestor. For example, FIG. 2B shows increasing light triggering image capturing component activation subtask carrying out module 231 carrying out a subtask of capturing image data (e.g., “take a picture of Puget Sound without the user knowing when the phone is removed from his pocket”) by activating an image capturing component (e.g., activating the shutter of a camera on the iPhone 5) when an amount of light is determined to be increasing (e.g., the iPhone 5 camera detects that the light is increasing rapidly, indicating that the phone is being removed from a pocket or bag), in an absence of information regarding the at least one task and/or the task requestor.

Referring again to FIG. 6G, operation 404 may include operation 698 depicting carrying out a subtask of capturing image data by storing image data when an image capturing component detects particular image data, in an absence of information regarding the at least one task and/or the task requestor. For example, FIG. 2B shows detected particular image data triggering storing image data subtask carrying out module 233 carrying out a subtask of capturing image data (e.g., “take a picture of the interior of the Peet's Coffee on 94^{th} street) by storing image data (e.g., taking a picture using the camera of a Droid Thunderbolt smartphone and storing it on an SD Card) when an image capturing component detects particular image data (e.g., when the phone is out, the camera is active, comparing the detected images to the known image patterns of Peet's Coffee, and when a match is found, storing the image data), in an absence of information regarding the at least one task and/or the task requestor.

Referring again to FIG. 6G, operation 404 may include operation 601 depicting collecting data regarding wireless networks from a wireless radio, in an absence of information regarding the at least one task and/or the task requestor. For example, FIG. 2B shows wireless network information collecting subtask carrying out module 235 collecting data regarding wireless networks (e.g., determining strength and/or frequency of wireless networks) from a wireless radio (e.g., using a wireless radio on a Dell Inspiron laptop tucked into a book bag of a student walking down the street), in an absence of information regarding the at least one task and/or the task requestor (e.g., the student may not even know the laptop is on, and the laptop does not know why the laptop is collecting the data or for whom the data is being collected).

Referring again to FIG. 6G, operation 601 may include operation 603 depicting collecting data regarding wireless networks from a wireless radio when wireless networks having a particular signal strength are located, in an absence of information regarding the at least one task and/or the task requestor. For example, FIG. 2B shows particular wireless network strength triggering wireless network information collecting subtask carrying out module 237 collecting data regarding wireless networks (e.g., determining strength and/or frequency, and encryption type) from a wireless radio (e.g., the wireless radio of an iTouch music player), when wireless networks having a particular signal strength are located (e.g., the iTouch ignores the wireless networks unless one or more wireless networks having a particular signal strength are detected), in an absence of information regarding the at least one task and/or the task requestor.

Referring now to FIG. 6H, operation 404 may include operation 605 depicting presenting instructions to fulfill at least one condition. For example, FIG. 2B shows at least one condition fulfilling instruction presenting module 239 presenting instructions (e.g., displaying visual instructions on a screen, or presenting audible instructions through an earphone or speaker) to fulfill at least one condition (e.g., “hold the interface device out of your pocket for 25 seconds”). The condition may be displayed so that a user may operate the interface device in a manner that will allow the interface device to carry out the subtask. In some embodiments, the user will not know what the subtask is.

Referring again to FIG. 6H, operation 404, which may include operation 605, also may include operation 607 depicting collecting data from a component when the at least one condition is fulfilled. For example, FIG. 2B shows fulfilled condition triggering component data collection subtask carrying out module 241 collecting data (e.g., temperature data from a temperature sensor which could have been skewed by body heat readings if pressed against the skin in a pocket) from a component (e.g., a thermometer of a smartphone) when the at least one condition is fulfilled (e.g., the interface device is outside a pocket for 25 seconds).

Referring again to FIG. 6H, operation 605 may include operation 609 depicting presenting instructions to move to a particular location. For example, FIG. 2B shows particular location movement instruction presenting module 243 presenting instructions (e.g., displaying visual instructions on a screen, or presenting audible instructions through an earphone or speaker) to move to a particular location (e.g., to move to a particular coffee shop, or to move 500 yards south, or to move to a different seat in the same aisle in a theater).

Referring again to FIG. 6H, operation 404 may include operation 611 depicting carrying out the one or more subtasks with insufficient information to carry out the at least one task. For example, FIG. 2B shows task insufficient information subtask execution module 245 carrying out the one or more subtasks (e.g., “take a picture of the view of the stage from seat 14B”) with insufficient information to carry out the at least one task (e.g., “determine which seat in the theater has the best view of the #1 violinist of the London Philharmonic”). In this example, the absence of information is that the device carrying out the subtask (taking the picture of the view of the stage) does not have all the information necessary to carry out the task, because the interface device taking the picture does not know what is being analyzed, or for what purpose (e.g., the view of the #1 violinist”).

Referring again to FIG. 6H, operation 404 may include operation 613 depicting carrying out the one or more subtasks using less information than would be present on a device carrying out the entire task. For example, FIG. 2B shows less task information subtask execution module 247 carrying out the one or more subtasks (e.g., “measure the number of wireless networks at the local Tully's coffee”) using less information than would be present on a device carrying out the entire task (e.g., the entire task here being “determine which Tully's coffee locations people use the most bandwidth in”). The interface device measuring the number of wireless networks has an absence of information because the interface device has less information than would be present on a device carrying out the entire task. The interface device has no idea whether it is measuring wireless networks for a particular area, or at a particular time, or for all Tully's coffee shops, or for all coffee shops in Seattle, or for coffee shops in a particular block, or public locations on a particular block, or whether the subtask is merely part of a larger task of measuring wireless network penetration in major cities.

Referring again to FIG. 6H, operation 404 may include operation 615 depicting carrying out the one or more subtasks with incomplete information regarding the at least one task and/or the task requestor. For example, FIG. 2B shows incomplete information subtask execution module 249 carrying out the one or more subtasks (e.g., “activate the image capturing component”) with incomplete information regarding the at least one task and/or the task requestor (e.g., here, the interface device with the active image capturing component has an absence of information because the interface device does not know what picture is being taken, or why, whether the picture is being taken to estimate crowd size, determine how long a particular line for a movie is, or to take a 360-degree picture of a landmark or city block, or to determine the atmosphere inside various coffee shops).

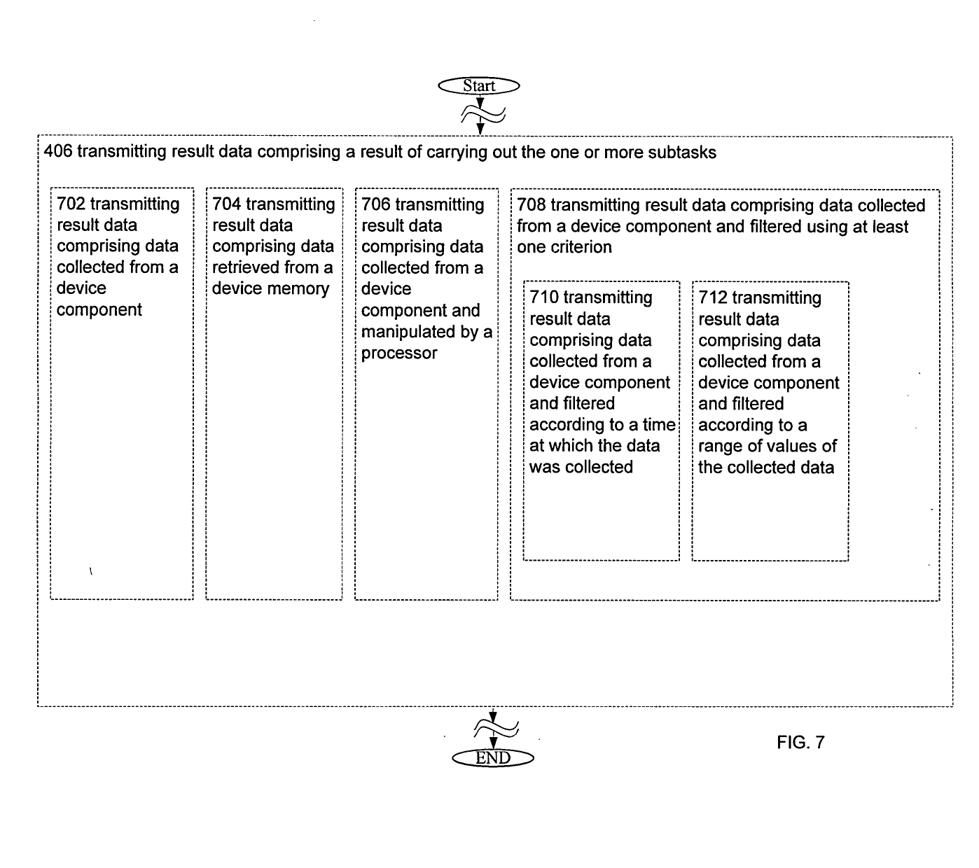

Referring now to FIG. 7, operation 406 may include operation 702 depicting transmitting result data comprising data collected from a device component. For example, FIG. 3 shows subtask collected result data transmitting module 302 transmitting result data (e.g., a picture taken from a camera of an iPhone of the Puget Sound at midnight) comprising data collected from a device component (e.g., image data collected from the image capturing component, e.g., the camera of the iPhone).

Referring again to FIG. 7, operation 406 may include operation 704 depicting transmitting result data comprising data retrieved from a device memory. For example, FIG. 3 shows subtask device memory retrieved data transmitting module 304 transmitting result data (e.g., temperature results stored from a thermometer of a smartphone sampling the temperature every fifteen minutes for the last eight hours) comprising data retrieved from a device memory (e.g., the temperature data is stored in a smartphone memory card).

Referring again to FIG. 7, operation 406 may include operation 706 depicting transmitting result data comprising data collected from a device component and manipulated by a processor. For example, FIG. 3 shows subtask device memory retrieved and processor manipulated data transmitting module 306 transmitting result data comprising data collected from a device component (e.g., velocity data captured from a speedometer of an in-car GPS navigation unit) and manipulated by a processor (e.g., the processor analyzes the data and throws out outlier readings which appear to be bad data (e.g., if the velocity data is consistently between 55 and 65 mph, removing data that is below 30 mph and above 100 mph)).

Referring again to FIG. 7, operation 406 may include operation 708 depicting transmitting result data comprising data collected from a device component and filtered using at least one criterion. For example, FIG. 3 shows component collected and criterion filtered data transmitting module 308 transmitting result data comprising data collected from a device component (e.g., data collected from an air quality sensor) and filtered using at least one criterion (e.g., only data collected when the air quality sensor was positioned on a particular block of the city is used).

Referring again to FIG. 7, operation 708 may include operation 710 depicting transmitting result data comprising data collected from a device component and filtered according to a time at which the data was collected. For example, FIG. 3 shows component collected and time-filtered data transmitting module 310 transmitting result data comprising data collected from a device component (e.g., sound data collected from a microphone of a Sony personal recorder) and filtered according to a time at which the data was collected (e.g., only data collected during a time when a particular band was known to be playing in the area is transmitted).

Referring again to FIG. 7, operation 708 may include operation 712 depicting transmitting result data comprising data collected from a device component and filtered according to a range of values of the collected data. For example, FIG. 3 shows component collected and value range-filtered data transmitting module 312 transmitting result data comprising data collected from a device component (e.g., signal strength data collected from a cellular radio of a BlackBerry 8800) and filtered according to a range of values of the collected data (e.g., only those signal strength data above a baseline signal strength are transmitted).

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuitry (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuitry, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled//implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those having skill in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory)

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “capable of being operably coupled”, to each other to achieve the desired functionality. Specific examples of operably coupled include but are not limited to physically mateable and/or physically interacting components and/or wirelessly interactable and/or wirelessly interacting components and/or logically interacting and/or logically interactable components.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.).

In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

1.-155. (canceled)

156. A system, comprising:
a portion of a requested-task subtask data receiving module configured to receive one or more subtasks that correspond to at least one portion of at least one task requested by a task requestor, wherein the one or more subtasks are configured to be carried out by two or more discrete interface devices;
an absent task and/or task requestor information subtask execution module configured to carry out the one or more subtasks in an absence of information regarding the at least one task and/or the task requestor; and
a subtask result data transmitting module configured to transmit result data comprising a result of carrying out the one or more subtasks.

157. (canceled)

158. The system of claim 156, wherein said portion of a requested-task subtask data receiving module comprises:
an instruction for retrieving data subtask receiving module configured to receive instructions for retrieving data corresponding to the one or more subtasks.

159. The system of claim 158, wherein said instruction for retrieving data subtask receiving module comprises:
an instruction for retrieving data from a memory subtask receiving module configured to receiving instructions for retrieving data corresponding to the one or more subtasks from a memory, wherein the one or more subtasks are configured to be carried out by two or more discrete interface devices.

160. The system of claim 159, wherein said instruction for retrieving data from a memory subtask receiving module comprises:
an instruction for retrieving data from a discrete interface device memory subtask receiving module configured to receive instructions for retrieving data corresponding to the one or more subtasks from a memory stored on a discrete interface device.

161. (canceled)

162. The system of claim 156, wherein said portion of a requested-task subtask data receiving module comprises:
an instruction for collecting subtask data receiving module configured to receive instructions for collecting data corresponding to the one or more subtasks.

163. The system of claim 156, wherein said portion of a requested-task subtask data receiving module comprises:
an instruction for monitoring subtask data receiving module configured to receive instructions for monitoring conditions corresponding to the one or more subtasks.

164. The system of claim 156, wherein said portion of a requested-task subtask data receiving module comprises:
an instruction for activating sensor of interface device subtask data receiving module configured to receive instructions for activating a sensor of an interface device corresponding to the one or more subtasks.

165. (canceled)

166. (canceled)

167. The system of claim 156, wherein said portion of a requested-task subtask data receiving module comprises:
an instruction for carrying out operation with preauthorization subtask data receiving module configured to receive instructions for carrying out an operation having a preauthorization, corresponding to the one or more subtasks.

168. (canceled)

169. (canceled)

170. (canceled)

171. (canceled)

172. (canceled)

173. (canceled)

174. The system of claim 156, wherein said portion of a requested-task subtask data receiving module comprises:
a portion of task requested by an interface device subtask receiving module configured to receive subtask data including one or more subtasks that correspond to at least one portion of at least one task requested by a discrete interface device.

175. The system of claim 156, wherein said portion of a requested-task subtask data receiving module comprises:
a portion of task requested by a communication network provider subtask receiving module configured to receive subtask data including one or more subtasks that correspond to at least one portion of at least one task requested by a provider of a communication network.

176. The system of claim 156, wherein said portion of a requested-task subtask data receiving module comprises:
a portion of task requested by subtask creator subtask receiving module configured to receive subtask data including one or more subtasks that correspond to at least one portion of at least one task requested by a subtask creator.

177. The system of claim 156, wherein said portion of a requested-task subtask data receiving module comprises:
a portion of task requested by subtask presentor subtask receiving module configured to receive subtask data including one or more subtasks that correspond to at least one portion of at least one task requested by a subtask presentor.

178. The system of claim 156, wherein said portion of a requested-task subtask data receiving module comprises:
a portion of task requested by news aggregator subtask receiving module configured to receive subtask data including one or more subtasks that correspond to at least one portion of at least one task requested by a news aggregator.

179. The system of claim 156, wherein said absent task and/or task requestor information subtask execution module comprises:
an absent task information subtask carrying out module configured to carry out the one or more subtasks without information regarding the at least one task.

180. The system of claim 156, wherein said absent task and/or task requestor information subtask execution module comprises:
an absent task requestor information subtask carrying out module configured to carry out the one or more subtasks without information regarding the task requestor.

181. The system of claim 156, wherein said absent task and/or task requestor information subtask execution module comprises:
an absent task requestor identity subtask carrying out module configured to carry out the one or more subtasks without knowledge of an identity of the task requestor.

182. The system of claim 156, wherein said absent task and/or task requestor information subtask execution module comprises:
an unknown task requestor identity subtask carrying out module configured to carry out the one or more subtasks when the task requestor is unknown.

183. (canceled)

184. The system of claim 156, wherein said absent task and/or task requestor information subtask execution module comprises:
an unknown task purpose subtask carrying out module configured to carry out the one or more subtasks absent information regarding a purpose of the at least one task.

185. The system of claim 156, wherein said absent task and/or task requestor information subtask execution module comprises:
a sensor data collection subtask carrying out module configured to collect data from at least one sensor.

186. (canceled)

187. (canceled)

188. (canceled)

189. (canceled)

190. (canceled)

191. The system of claim 156, wherein said absent task and/or task requestor information subtask execution module comprises:
a data generation subtask carrying out module configured to carry out the one or more subtasks by generating data.

192. (canceled)

193. The system of claim 156, wherein said absent task and/or task requestor information subtask execution module comprises:
a presenting instruction for executing operations subtask carrying out module configured to present instructions for executing one or more operations.

194. The system of claim 193, wherein said presenting instruction for executing operations subtask carrying out module comprises:
a displaying instruction for executing operations subtask carrying out module configured to display instructions for executing one or more operations.

195. The system of claim 156, wherein said absent task and/or task requestor information subtask execution module comprises:
a data collection by component activation subtask carrying out module configured to activate a component to collect data to carry out the one or more subtasks.

196. The system of claim 195, wherein said data collection by component activation subtask carrying out module comprises:
a predetermined condition data collection by component activation subtask carrying out module configured to activate a component to collect data upon detection of a predetermined condition.

197. (canceled)

198. (canceled)

199. (canceled)

200. The system of claim 196, wherein said predetermined condition data collection by component activation subtask carrying out module comprises:
a particular component detecting particular condition subtask carrying out module configured to activate a particular component upon detection of a particular condition by the particular component.

201. The system of claim 200, wherein said particular component detecting particular condition subtask carrying out module comprises:
a speedometer component detecting particular speed subtask carrying out module configured to activate a speedometer to collect data upon detection of a particular speed by the speedometer.

202. (canceled)

203. (canceled)

204. (canceled)

205. (canceled)

206. (canceled)

207. (canceled)

208. (canceled)

209. The system of claim 196, wherein said predetermined condition data collection by component activation subtask carrying out module comprises:
an image capturing subtask carrying out module configured to capture image data by activating an image capturing component.

210. (canceled)

211. The system of claim 196, wherein said predetermined condition data collection by component activation subtask carrying out module comprises:
a particular location triggering component activation subtask carrying out module configured to activate a component at a particular location.

212. The system of claim 156, wherein said absent task and/or task requestor information subtask execution module comprises:
a prompting component activation subtask carrying out module configured to prompt a component activation to collect data.

213. The system of claim 156, wherein said absent task and/or task requestor information subtask execution module comprises:
a particular action for particular component prompting module configured to prompt a particular action to be carried out on a particular component; and
a particular action triggering component data collecting module configured to collect data from the component upon carrying out the particular action.

214. The system of claim 213, wherein said particular action for particular component prompting module comprises:
an image capturing component pointed at particular object prompting module configured to prompt activation of an image capturing component upon detection of the image capturing component pointed at a particular object.

215. The system of claim 213, wherein said particular action for particular component prompting module comprises:
an image capturing component pointed in particular direction prompting module configured to prompt activation of an image capturing component upon detection of the image capturing component pointed in a particular direction.

216. (canceled)

217. (canceled)

218. The system of claim 156, wherein said absent task and/or task requestor information subtask execution module comprises:
a component collecting data during different component use subtask carrying out module configured to activate a component during use of a different component.

219. (canceled)

220. (canceled)

221. (canceled)

222. The system of claim 156, wherein said absent task and/or task requestor information subtask execution module comprises:
a wireless network information collecting subtask carrying out module configured to collect data regarding detected wireless networks from a wireless radio.

223. The system of claim 222, wherein said wireless network information collecting subtask carrying out module comprises:
a particular wireless network strength triggering wireless network information collecting subtask carrying out module configured to collect data regarding detected wireless networks upon detection of one or more wireless networks having a particular signal strength.

224. The system of claim 156, wherein said absent task and/or task requestor information subtask execution module comprises:
an at least one condition fulfilling instruction presenting module configured to present instructions to fulfill at least one condition; and
a fulfilled condition triggering component data collection subtask carrying out module configured to collect data upon fulfillment of the at least one condition.

225. The system of claim 224, wherein said at least one condition fulfilling instruction presenting module comprises:
a particular location movement instruction presenting module configured to present instructions to move to a particular location.

226. The system of claim 156, wherein said absent task and/or task requestor information subtask execution module comprises:
a task insufficient information subtask execution module configured to carry out the one or more subtasks with insufficient information to carry out the at least one task.

227. (canceled)

228. (canceled)

229. The system of claim 156, wherein said subtask result data transmitting module comprises:
a subtask collected result data transmitting module configured to transmit result data collected from a device component.

230. The system of claim 156, wherein said subtask result data transmitting module comprises:
a subtask device memory retrieved data transmitting module configured to transmit result data retrieved from a memory.

231. The system of claim 156, wherein said subtask result data transmitting module comprises:
a subtask device memory retrieved and processor manipulated data transmitting module configured to transmit data retrieved from memory and manipulated by a processor.

232. The system of claim 156, wherein said subtask result data transmitting module comprises:
a component collected and criterion filtered data transmitting module configured to transmit data collected from a component and filtered according to at least one criterion.

233. (canceled)

234. (canceled)
